(19) United States
(12) Patent Application Publication
(10) Pub. No.: US 2012/0011453 A1
(43) Pub. Date: Jan. 12, 2012

(54) METHOD, STORAGE MEDIUM, AND USER TERMINAL

(75) Inventors: Masataka SHIMONO, Fujisawa-shi (JP); Tatsushi ISHIDA, Koshigaya-shi (JP)

(73) Assignee: NAMCO BANDAI GAMES INC., Tokyo (JP)

(21) Appl. No.: 13/177,113

(22) Filed: Jul. 6, 2011

(30) Foreign Application Priority Data
Jul. 8, 2010 (JP) 2010-155886

(51) Int. Cl. G06F 3/01; G06F 15/16

(52) U.S. Cl. 715/753

(57) ABSTRACT

A user terminal displays a field screen on which an avatar corresponding to each following user is disposed. A balloon that indicates that a message has been posted by the corresponding following user is displayed together with the avatar. The message posted by the corresponding following user is displayed when the user has touched the balloon. The user can edit the avatar by touching the avatar.

Japanese Patent Application No. 2010-155886 filed on Jul. 8, 2010, is hereby incorporated by reference in its entirety.

### BACKGROUND

The present invention relates to a method, a storage medium, and a user terminal.

A social networking service (SNS), a bulletin board system, and the like have been popular since the users can keep a diary or have a conversation or discussion by posting without meeting in the same place (see JP-A-2007-94551, for example).

mixi (registered trademark) (i.e., SNS) allows the user to register favorite friends as “my mixi”, and open his diary to them. TWITTER (registered trademark) (i.e., blog system) allows the user to register favorite users as “following users”, and display messages posted by the following users in time series. Such a function of allowing the user to keep track of messages posted by favorite users is highly convenient to the user.

### SUMMARY

According to one aspect of the invention, there is provided a method that is implemented by a user terminal that can communicate with a given posting site, the method comprising:

setting a character corresponding to a following user;

displaying the character in a given virtual space; and

distinguishably displaying the character corresponding to the following user when message data about the following user is present in the posting site.

According to another aspect of the invention, there is provided a user terminal that can communicate with a given posting site, the user terminal comprising:

a character setting section that sets a character corresponding to a following user;

a character display control section that displays the character set by the character setting section in a given virtual space; and

a distinguishable display section that distinguishably displays the character corresponding to the following user when message data about the following user is present in the posting site.

### BRIEF DESCRIPTION OF THE DRAWINGS

FIG. 1 is a configuration diagram showing a message posting system.

FIG. 2 shows an example of the appearance of a user terminal.

FIG. 3 is a view illustrating a new message.

FIG. 4 is a view illustrating a direct message.

FIGS. 5A and 5B are views illustrating a quote message.

FIG. 6A shows the format of a new message, FIG. 6B shows the format of a direct message, and FIG. 6C shows the format of a quote message.

FIG. 7 is a view showing an example of a follow function.

FIG. 8 shows an example of a field screen.

FIG. 9 is a view illustrating a field screen generation principle.

FIG. 10 shows an example of a message details screen.

FIG. 11 shows an example of a field screen when the user has touched an avatar.

FIG. 12 shows an example of an avatar edit screen.

FIG. 13 shows an example of a message screen.

FIG. 14 shows an example of a field screen when the user has touched an avatar button.

FIG. 15 shows an example of a main screen.

FIG. 16 shows an example of a field screen when the user has touched an update button.

FIG. 17 shows an example of a following user list screen.

FIG. 18 shows an example of a field screen when the user has touched a sort button.

FIG. 19 is a view illustrating arrangement of avatars in a field.

FIG. 20 shows an example of a field screen when an item is attached to an avatar.

FIG. 21 shows an example of a field screen when an avatar makes a motion.

FIG. 22 is a view showing the functional configuration of a server system.

FIG. 23 shows a data configuration example of account registration data.

FIG. 24 is a view showing the functional configuration of a user terminal.

FIG. 25 shows a data configuration example of following user management data.

FIG. 26 shows a data configuration example of an item table.

FIG. 27 shows a data configuration example of an instruction command table.

FIG. 28 shows a data configuration example of avatar placement data.

FIG. 29 shows a data configuration example of registered avatar data.

FIG. 30 shows a data configuration example of an avatar part table.

FIG. 31A is a view illustrating the format of a message when posting an avatar, and FIG. 31B is a view illustrating the format of a message when posting an instruction command.

FIG. 32 shows a data configuration example of user message analysis result data.

FIG. 33 shows a data configuration example of message analysis result data.

FIG. 34 shows a data configuration example of an item generation condition table.

FIG. 35 is a flowchart of a post management process performed by a server system.

FIG. 36 is a flowchart of a message posting process performed by a user terminal.

FIG. 37 is a flowchart that follows the flowchart shown in FIG. 36.

FIG. 38 is a flowchart of a message analysis process.

FIG. 39 is a flowchart of a field display process.

FIG. 40 is a flowchart of an avatar-modifying process.

FIG. 41 is a flowchart of an avatar process.

FIG. 42 is a flowchart that follows the flowchart shown in FIG. 41.

FIG. 43 is a flowchart of a field update process.

FIG. 44 is a flowchart of an avatar sort process.

FIG. 45 is a flowchart of a regular update process.

FIG. 46 shows an example of a field screen when a message includes an image.

### DESCRIPTION OF EXEMPLARY EMBODIMENTS

According to the above system, information posted by a favorite user is text information, and the text information is merely displayed. Several aspects of the invention may implement interesting display control instead of monotonously displaying text information.

According to one embodiment of the invention, there is provided a method that is implemented by a user terminal that can communicate with a given posting site, the method comprising:

setting a character corresponding to a following user;

displaying the character in a given virtual space; and

distinguishably displaying the character corresponding to the following user when message data about the following user is present in the posting site.

According to another embodiment of the invention, there is provided a user terminal that can communicate with a given posting site, the user terminal comprising:

a character setting section that sets a character corresponding to a following user;

a character display control section that displays the character set by the character setting section in a given virtual space; and

a distinguishable display section that distinguishably displays the character corresponding to the following user when message data about the following user is present in the posting site.

According to the above configuration, a character can be set and displayed corresponding to the following user. The character is distinguishably displayed when the message data about the following user. This makes it possible to more interestingly display the message posted by the following user instead of merely displaying a text of the message posted by the following user.

In the method, the setting of the character may include setting the character corresponding to the following user by designing each part of the character based on an operation input performed by a user.

According to the above configuration, the user can design the character that is set corresponding to the following user. For example, when the user knows the figure of the following user, the user can design the character to resemble the following user. This makes it possible to implement a more interesting system.

The method may further comprise:

posting the message data about the user including design data about the character to the posting site.

According to the above configuration, the user can post the message data including the design data about the character. Specifically, another user can use the character designed by the user. This makes it possible for the user to design a celebrity character and open it to another user, or design his own character, and provide the following users with the design data, for example.

The method may further comprise:

generating the character based on design data about the character when the message data about the following user includes the design data.

According to the above configuration, when the message posted by the following user includes the design data about the character, a character is generated based on the design data. This makes it possible for the user to use the same character as the character that has been designed and posted by the following user.

In the method,

the distinguishably displaying of the character may include displaying a given accompanying display object to follow the character corresponding to the following user.

According to the above configuration, when the message data about the following user has been received, the character corresponding to the following user is distinguishably displayed using a given accompanying display object. The accompanying display object may be a balloon used for cartoons, or an item having an attractive color or size, for example. This makes it possible to implement interesting display.

The method may further comprise:

selecting a document destination character from characters displayed in the virtual space; and

transmitting document data to a following user corresponding to the document destination character.

According to the above configuration, when the user has selected one of the characters displayed in the virtual space, the document data can be transmitted to the following user corresponding to the selected character. The character visually indicates whether or not the message data about the following user corresponding to the character has been received. According to the above configuration, the character can have a push-type (active) role of transmitting the document data instead of a pull-type (passive) role of receiving the message data.

The method may further comprise:

changing a position of the character in the virtual space based on at least one of a content of the message data, a date of post, and a post frequency of the following user.

The method may further comprise:

arranging characters disposed in the virtual space based on at least one of a date of post and a post frequency of the following user.

According to the above configuration, since the characters are arranged based on the date of post and the post frequency of the following user, the user can easily determine the date of post and the post frequency.

The method may further comprise:

grouping characters disposed in the virtual space based on whether or not the message data about the following user includes a given keyword.

According to the above configuration, since the characters can be grouped based on the keyword included in the message data about the following user, the user can easily determine the tendency of the message of each following user from the character.

The method may further comprise:

determining whether or not an item generation condition has been satisfied based on at least one of a content of the message data and a post count of the following user; and

updating a character corresponding to a following user who has satisfied the item generation condition with the character to which a given item is attached.

According to the above configuration, when the content of the message data or the post count of the following user has satisfied the item generation condition, the character corresponding to the following user who has satisfied the item generation condition is updated with the character to which a given item is attached. Specifically, an item can be attached to the character based on the content of the message data or the post count of the following user. This makes it possible to more interestingly display the character. On the other hand, the system provider can promote posting and following to promote utilization of the system.

The method may further comprise:

changing a display state of the character corresponding to the following user when the message data about the following user includes image data or identification information that indicates a location of the image data.

According to the above configuration, the message data can be posted together with image data or the identification information that indicates the location of the image data. When the received message data about the following user includes image data or the identification information that indicates the location of the image data, the display state of the character corresponding to the following user is changed to a given display state. Therefore, the user can easily identify a message including image data or the identification information that indicates the location of the image data based on the character.

The method may further comprise:

analyzing a content of the message data about the following user; and

controlling a motion of the corresponding character based on a result of the analysis.

According to the above configuration, the content of the message data about the following user is analyzed, and the motion of the character corresponding to the following user is controlled based on the analysis result. Therefore, the character can be displayed in various ways depending on the content of the message data. This makes it possible to implement a more interesting system.

In the method,

the analyzing of the content of the message data may include analyzing a use frequency and/or a use count of a term by each following user based on the term included in the message data.

According to the above configuration, the motion of the character is changed based on the use frequency or the use count of a term included in the message data about the following user.

In the method,

the analyzing of the content of the message data may include determining whether or not a movement instruction command and/or a motion instruction command is included in the message data,

the method may further comprise:

causing the corresponding character to make a movement and/or a motion in the virtual space based on the movement instruction command and/or the motion instruction command when it has been determined that the movement instruction command and/or the motion instruction command is included in the message data.

According to the above configuration, when the movement instruction command or the motion instruction command is included in the message data, the corresponding character makes a movement/motion based on the instruction command. This makes it possible to implement interesting display control that causes the character to make a motion by merely receiving the message data about the following user.

The method may further comprise:

determining whether or not related message data is included in the message data about the following user, the related message data indicating that a message relates to a message posted by another user;

setting a degree of intimacy between each following user using a result of determination as to whether or not the related message data is included in the message data; and

causing a character corresponding to a following user for whom the degree of intimacy has satisfied a given condition to make a predetermined motion.

According to the above configuration, the degree of intimacy between each following user is set based on whether or not the related message data is included in the message data about the following user. The character corresponding to the following user for whom the degree of intimacy has satisfied a given condition is caused to make a predetermined motion. This makes it possible to implement interesting display control that causes two characters with the highest degree of intimacy to holds hands by merely receiving the message data, for example.

According to another embodiment of the invention, there is provided a non-transitory storage medium storing a program that causes a computer to execute the above method.

The term “storage medium” used herein includes a magnetic disk, an optical disk, an IC memory, and the like.

Exemplary embodiments of the invention are described below with reference to the drawings. The following exemplary embodiments mainly illustrate an example of a message posting system that allows the user to post a message from a user terminal.

System Configuration

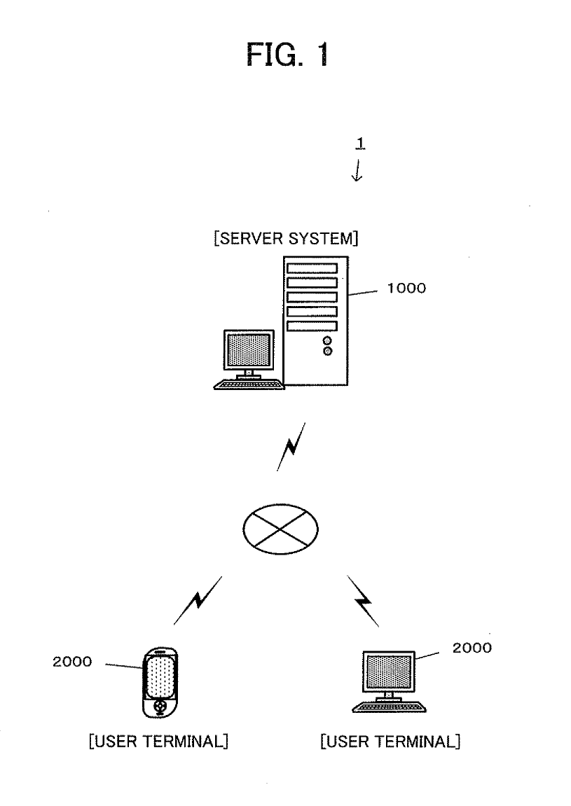

FIG. 1 is a view showing a schematic configuration of a message posting system 1 according to one embodiment of the invention. The message posting system 1 shown in FIG. 1 includes a server system 1000 and a user terminal 2000, the server system 1000 and the user terminal 2000 being connected via a communication channel N so that the server system 1000 and the user terminal 2000 can exchange data. The communication channel N is a communication path via which data can be exchanged. The communication channel N includes the Internet, a local network (LAN), a private network, another network, a router, and the like.

The server system 1000 is installed in and managed by the operating company of the message posting system 1, and includes a known server computer system. The server system 1000 mainly functions as (1) a management server that manages an account relating to a message posting service, and (2) as a web site server that provides and manages a website for providing the message posting service via the Internet.

The user terminal 2000 is owned by the user, and is implemented by an electronic instrument such as a mobile phone (including a smartphone), a personal computer, an ultra-mobile personal computer (UMPC), or a personal digital assistant (PDA). The user terminal 2000 has a web browser function, and allows the user to view the website managed by the server system 1000 via the communication channel N.

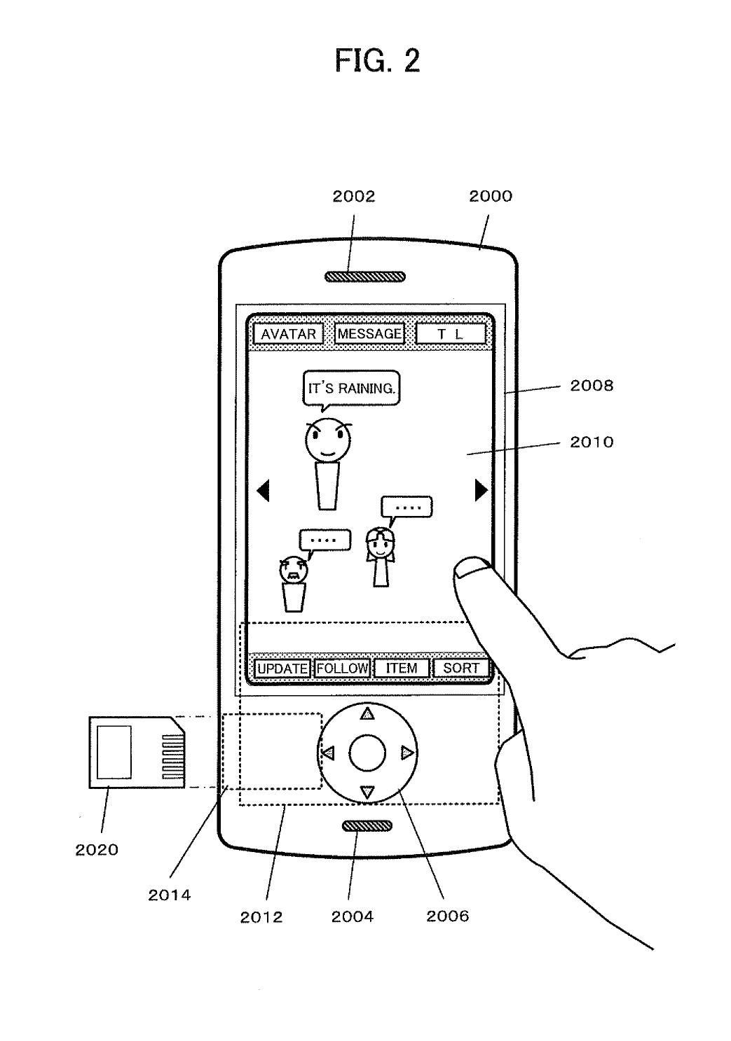

FIG. 2 is an external view showing a mobile phone that is an example of the user terminal 2000. As shown in FIG. 2, the mobile phone includes a hand-held housing, a speaker 2002 (used for a telephone call), a microphone 2004 (used for a telephone call), an operation key 2006 that is used to input a dial number and the like, and a liquid crystal display 2008. A touch panel 2010 that detects a touch position with the finger or the like is provided over the entire display screen of the liquid crystal display 2008.

The user terminal 2000 includes a control device 2012, and a memory card reader 2014 that can read or write data from or into a removable memory card 2020.

The control device 2012 includes a microprocessor (e.g., central processing unit (CPU), graphics processing unit (GPU), and digital signal processor (DSP)), an application-specific integrated circuit (ASIC), and an IC memory (e.g., VRAM, RAM, and ROM). The control device 2012 also includes a wireless communication device that connects to the communication channel N and implements wireless communication, a driver circuit that drives the liquid crystal display 2008, a driver circuit that drives the touch panel 2010, a circuit that receives a signal from the operation key 2006, an amplifier circuit that outputs a sound signal to the speaker 2002, and a circuit that receives or outputs a signal from or to the memory card reader 2014 (i.e., interface (I/F) circuit). The devices included in the control device 2012 are electrically connected via a bus circuit so that the devices can exchange data and signals.

Outline 1

The message posting system 1 provides the message posting service. The message posting service is similar to a blog service, and allows the user to post a message on a website, or view a message posted by another user. The user can utilize the message posting service provided by the server system 1000 by accessing a given website managed by the server system 1000 using the user terminal 2000.

Specifically, the user registers himself with the server system 1000 using the user terminal 2000, and creates an account. The server system 1000 then assigns a homepage (my page) to the user. The user posts a message on the my page, or views a message posted by another user through the my page. A message posted by the user, and a message posted by another user (follower) are displayed (listed) on the my page in time series. Note that the message posting service according to one embodiment of the invention allows the user to post only a text message.

A message is classified as “new message”, “direct message”, or “quote message”.

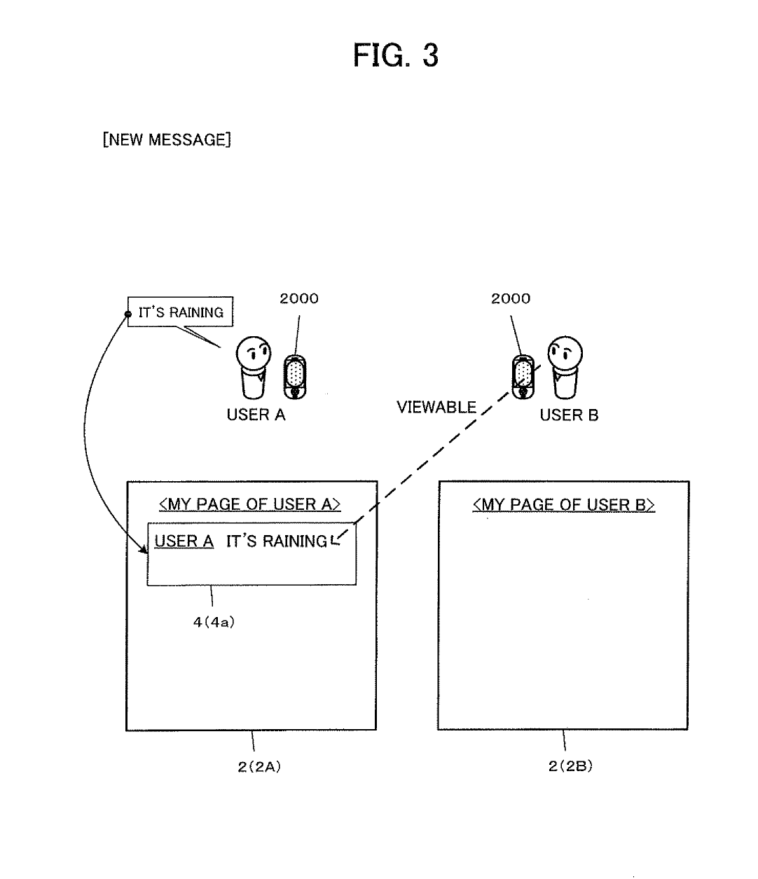

FIG. 3 is a view showing an outline of the new message. Specifically, when the user has posted a message, the posted message 4 is displayed on a my page 2. FIG. 3 shows an example in which a user A has posted a new message. In this case, the posted message 4a is displayed on a my page 2A of the user A. Another user B can view the message 4a posted by the user A. The name of the user who has posted the message 4 is displayed on the my page 2 at the beginning of the message 4.

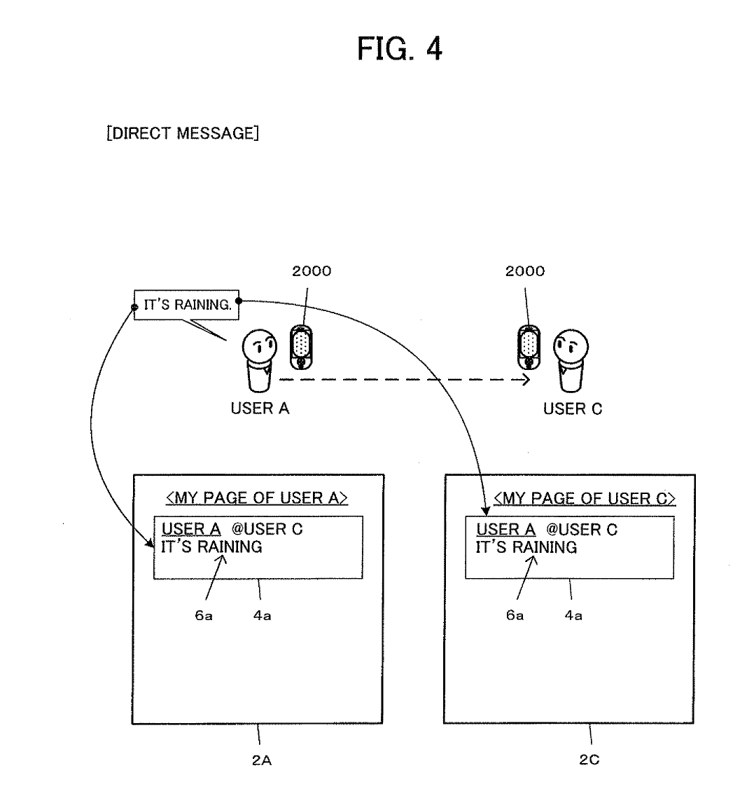

FIG. 4 is a view showing an outline of the direct message. The direct message is a message that designates the destination. When the user has posted a message that designates the destination user, the posted message 4 is displayed on the my page 2 of the user, and is also displayed on the my page 2 of the destination user. FIG. 4 shows an example in which the user A has posted a message that designates a user C as the destination. In this case, the posted message 4a is displayed on the my page 2 of the user A, and is also displayed on a my page 2C of the user C (destination). Note that the name of the destination user is added to the head of the message. An identifier 6a (symbol “@” in FIG. 4) that indicates that the message is a direct message is added at the beginning of the name of the destination user.

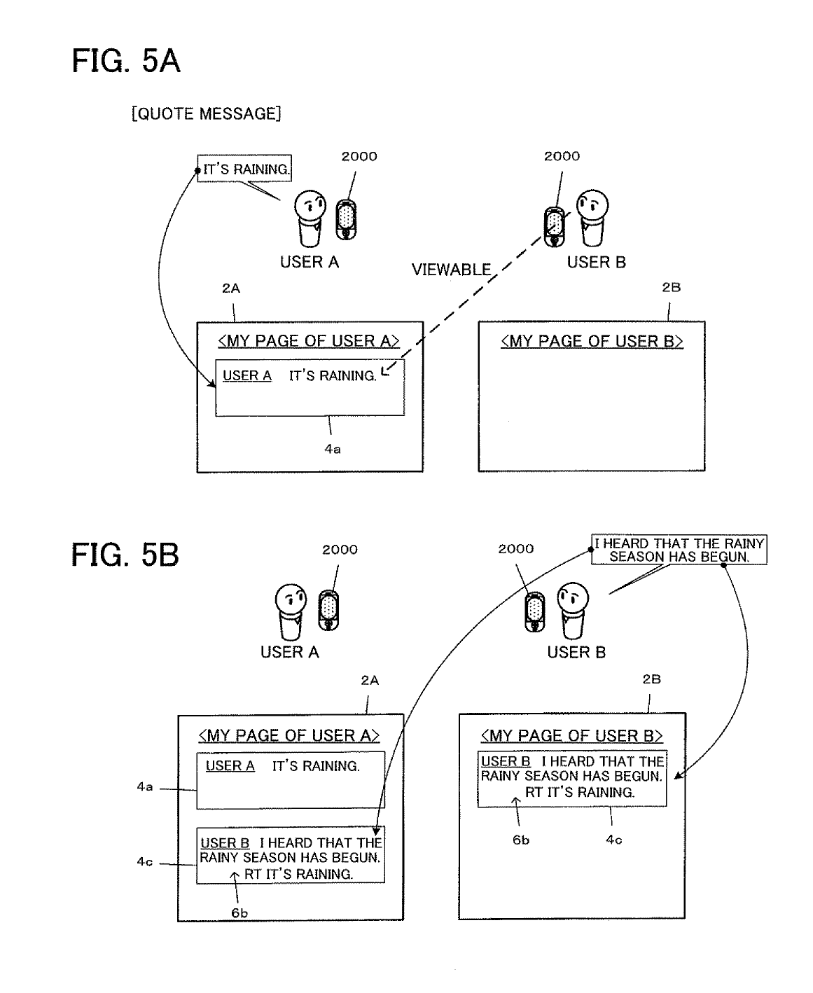

FIGS. 5A and 5B are views showing an outline of the quote message. The quote message is a message that quotes a message that has been posted by the user or another user (message related to a message posted by another user). When the user has posted a message that quotes a message that has been previously posted, the posted message 4 is displayed on the my page 2 of the user, and is also displayed on the my page 2 of the user who has posted the quoted message. FIGS. 5A and 5B show an example in which the user B has posted a message that quotes a message that has been posted by the user A. In FIG. 5A, a message 4a posted by the user A is displayed on the my page 2A of the user A. As shown in FIG. 5B, the user B then posts a message that quotes the message 4a that has been posted by the user A. In this case, the posted message 4c posted by the user B is displayed on the my page 2B of the user B, and is also displayed on the my page 2A of the user A. An identifier 6b (characters “RT” in FIG. 5B) that indicates that the message is a quote message is added at the beginning of the quoted message. The user can add his message to the quoted message.

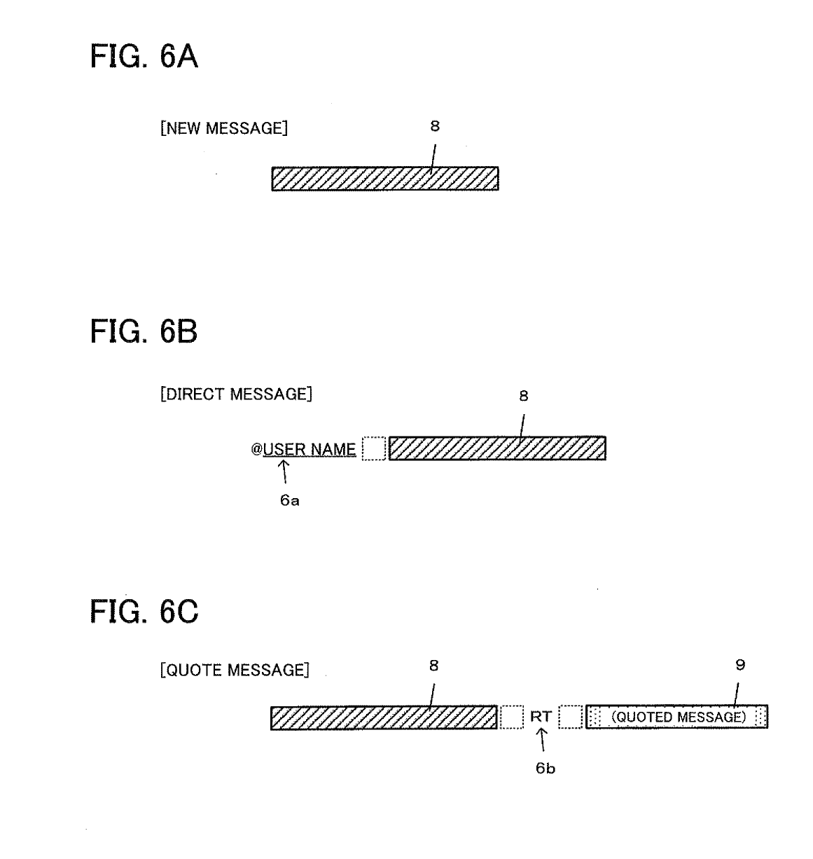

FIGS. 6A to 6C are views showing the format of each message. FIG. 6A shows the format of the new message, FIG. 6B shows the format of the direct message, and FIG. 6C shows the format of the quote message. Note that the message is text data.

As shown in FIG. 6A, the new message includes only a message 8 input by the user.

In the direct message shown in FIG. 6B, the identifier 6a (symbol “@” in FIG. 6B) that indicates that the message is a direct message, and the name of the destination user are added at the beginning of the message. The message 8 input by the user follows after one space.

As shown in FIG. 6C, the quote message includes the message 8 input by the user, the identifier 6b (characters “RT” in FIG. 6C) that indicates that the message is a quote message, and a quoted message 9 in this order. One space precedes and follows the identifier 6b.

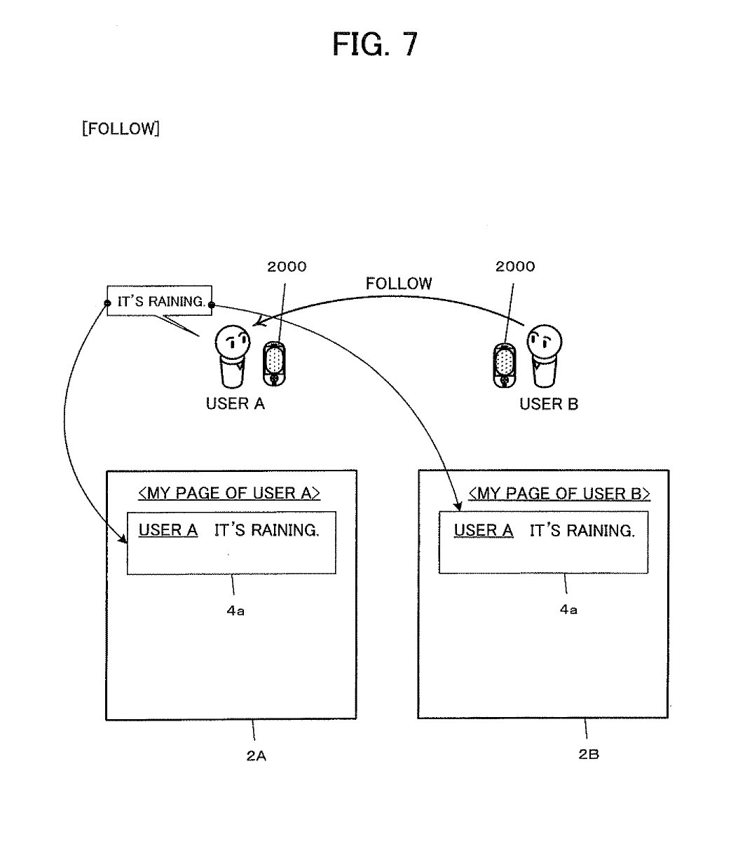

The message posting service according to one embodiment of the invention has a “follow” function for registering another user. Specifically, when the user has followed another user, a message posted by the other user is displayed on the my page of the user. FIG. 7 is a view showing an example of the follow function. In FIG. 7, the user B follows the user A. In this case, when the user A has posted a message, the posted message 4a is displayed on the my page 2A of the user A, and is also displayed on the my page 2B of the user B who follows the user A.

Outline 2

The flow of operations performed using the user terminal 2000 is described below with reference to the display screen of the liquid crystal display 2008. Note that the user operates the user terminal 2000 by performing a touch operation on the display screen.

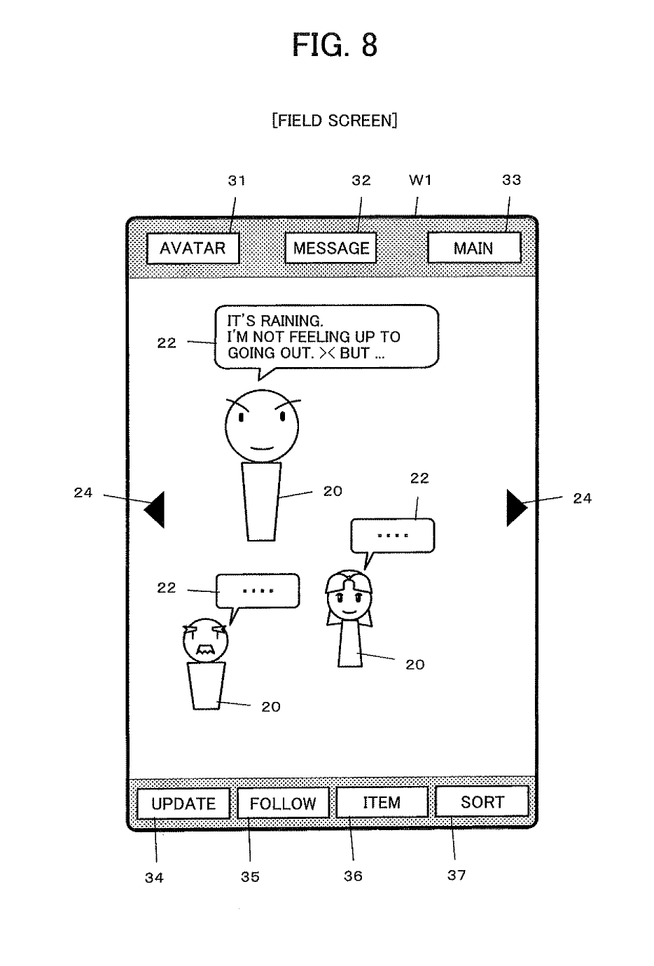

The user accesses a given website using the user terminal 2000, and inputs the user ID, the password, and the like on a login screen. A field screen W1 shown in FIG. 8 is then displayed.

FIG. 8 is a view showing an example of the field screen W1. As shown in FIG. 8, an avatar 20 that is a character set corresponding to each following user is displayed on the field screen W1.

The avatar 20 is created by adding various parts (e.g., eyes, nose, mouth, and hair) to an initial avatar that is formed by a body and a head (i.e., basic parts). A plurality of types of each part are provided. Various avatars 20 that differ in appearance can be created by arbitrarily selecting and combining the parts.

A balloon 22 that shows a message posted by the corresponding following user is displayed together with the avatar 20. The balloon 22 is displayed when the following user corresponding to the avatar 20 has posted a message within a given period (e.g., one day). The balloon 22 may be displayed when a message posted by the following user corresponding to the avatar 20 has not been read.

The avatar 20 and the balloon 22 corresponding to the following user who has posted the latest message are enlarged, and part (e.g., 30 characters from the beginning) of the latest message (text) posted by the following user is displayed. A message is not displayed (displayed as “ . . . ” in FIG. 8) within the remaining balloons 22.

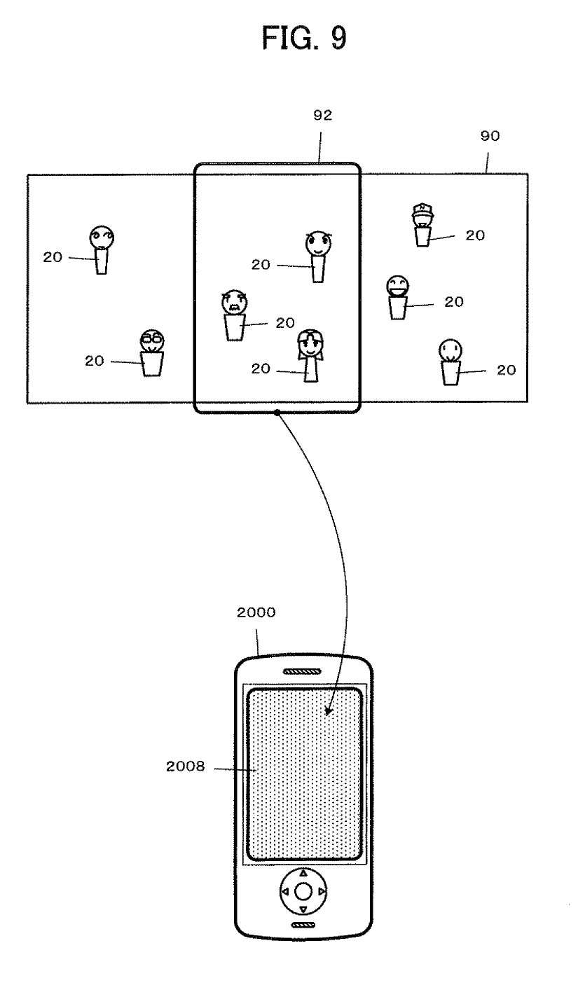

As shown in FIG. 9, an area of a field 90 (i.e., a virtual two-dimensional space where the avatar 20 (character) is disposed) corresponding to a display range 92 having a given size (about ⅓rd of the entire field in FIG. 9) is displayed within the field screen W1. The user can view the area of the field that is not displayed within the field screen W1 by touching a scroll cursor 24 displayed on each end of the field screen W1 (i.e., scrolling the image to the right or left).

When the user has touched the balloon 22 displayed on the field screen W1, a message details screen W2 that displays the latest message that has been posted by the following user corresponding to the balloon 22 that has been touched by the user is displayed.

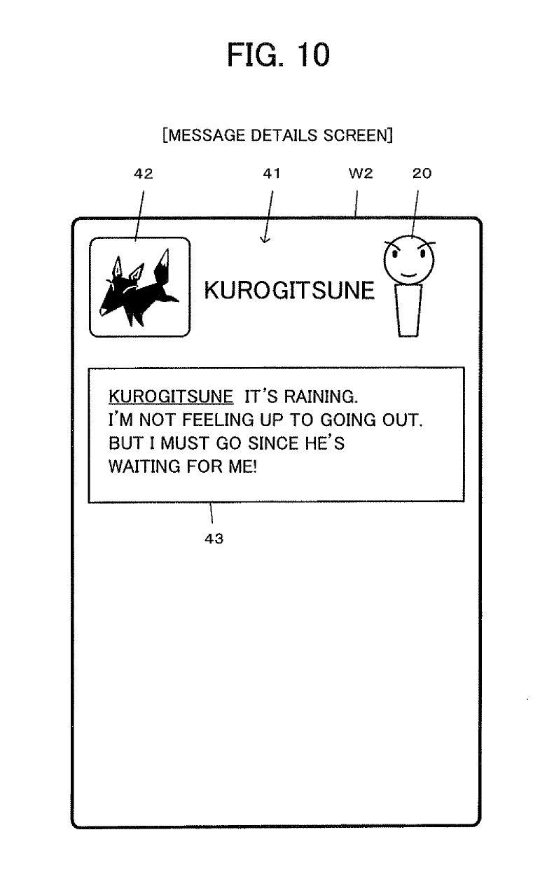

FIG. 10 is a view showing an example of the message details screen W2. As shown in FIG. 10, the name of the user who has posted the message, and a full text 43 of the message are displayed on the message details screen W2.

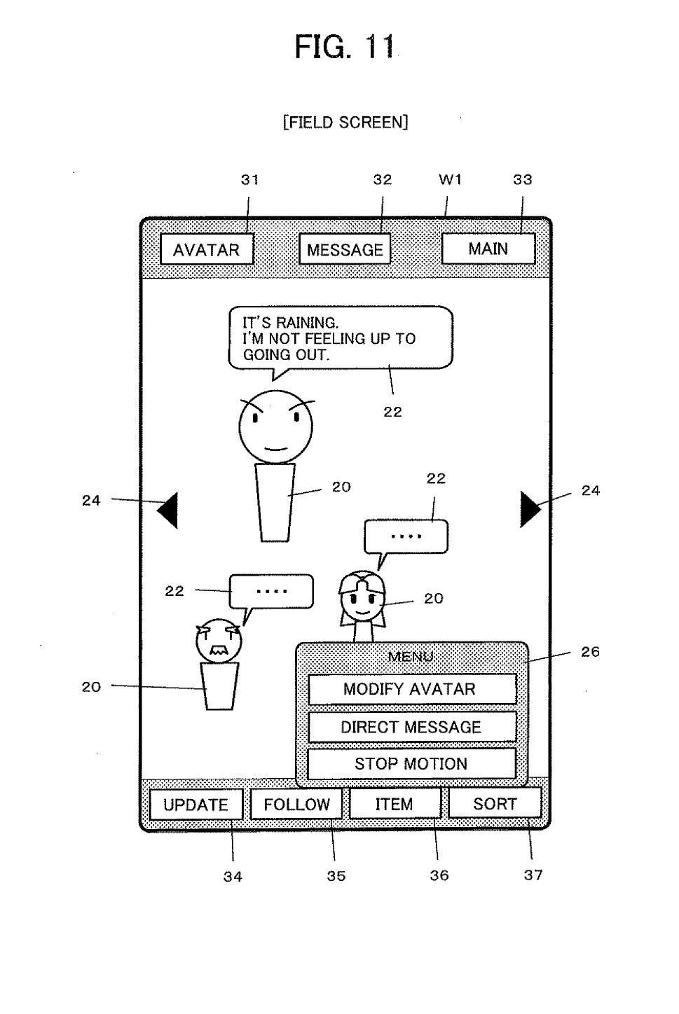

As shown in FIG. 11, when the user has touched the avatar 20 displayed on the field screen W1, an avatar menu 26 about the avatar 20 that has been touched by the user is displayed as a pop-up menu. The avatar menu 26 includes an item “MODIFY AVATAR” that allows the user to display an avatar edit screen W3 and modify the avatar 20, an item “DIRECT MESSAGE” that allows the user to post a direct message to the corresponding following user, and an item “STOP MOTION” that allows the user to stop the motion of the avatar 20. When the user has touched the item “MODIFY AVATAR” displayed within the avatar menu 26, the avatar edit screen W3 that allows the user to modify the avatar 20 is displayed.

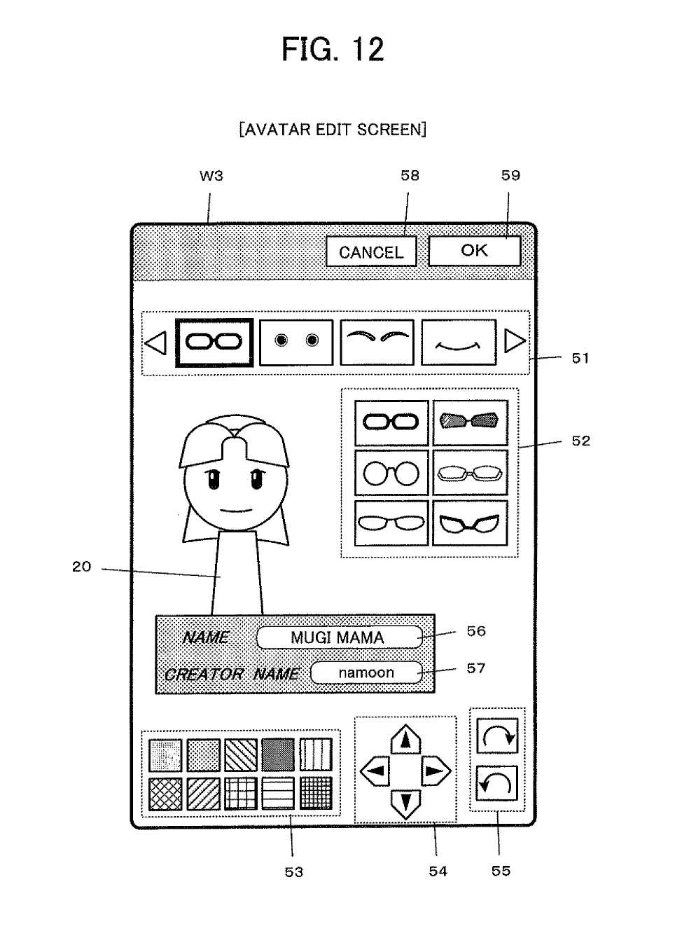

FIG. 12 is a view showing an example of the avatar edit screen W3. As shown in FIG. 12, the edit target avatar 20 is displayed on the avatar edit screen W3. Basic parts, a part type list 51 (i.e., a list of the types of parts that can be attached to the avatar 20), and a candidate part list 52 (i.e., a list of candidate parts corresponding to the part type selected in the part type list 51) are also displayed on the avatar edit screen W3.

In FIG. 12, a part type “glasses” is selected, and a list of candidate glasses that differ in shape is displayed. A color palette 53 that is used to change the color of the part, an arrow key 54 that is used to move the part in the vertical direction and the horizontal direction, and a rotation tool 55 that is used to rotate the part clockwise or counterclockwise are displayed on the avatar edit screen W3 as part adjustment tools. A user name 56 of the following user corresponding to the avatar 20, and a user name 57 of the user who has created the avatar 20 are displayed on the avatar edit screen W3 as information about the edit target avatar.

The user can modify the avatar 20 by changing each part or adjusting the position, the direction, or the color of each part using the avatar edit screen. When the user has touched a registration button 59 after revising the avatar 20, the modified avatar 20 is registered, and the creator name of the avatar 20 is updated with the name of the user.

When the user has touched the item “DIRECT MESSAGE” displayed within the avatar menu 26, a message screen W4 that allows the user to post a direct message to the following user corresponding to the avatar 20 is displayed.

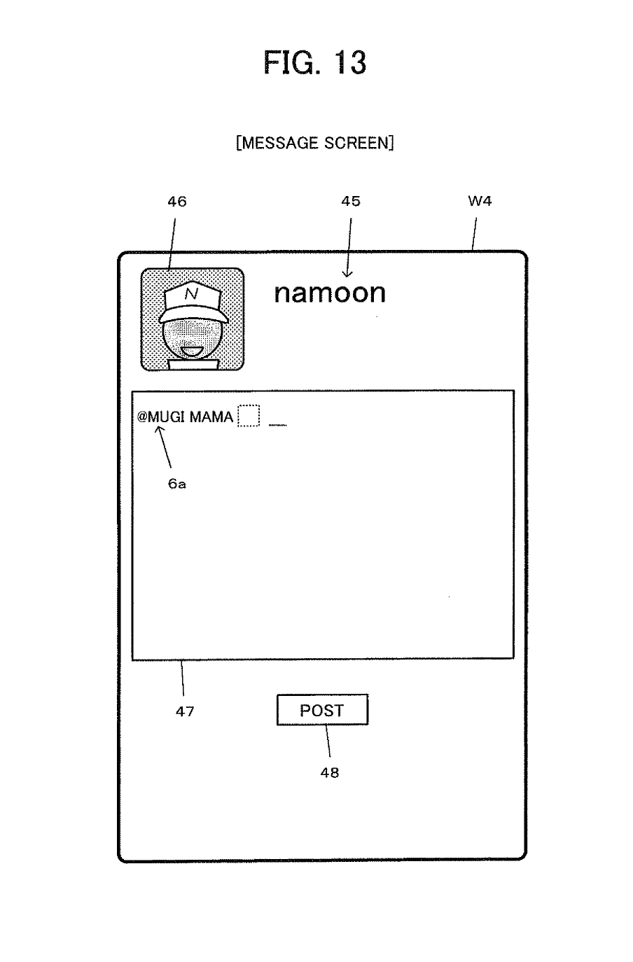

FIG. 13 is a view showing an example of the message screen W4. As shown in FIG. 13, an input area 47 for inputting a message is displayed on the message screen W4. The identifier 6a (“@”) and the name of the destination user have been automatically input to the input area 47. In the example shown in FIG. 13, the name of the following user corresponding to the avatar 20 that has been touched by the user using the field screen W1 has been input as the name of the destination user. The user inputs a text message after the name of the destination user. When the user has input a message, and touched a “POST” button 48, the input message (document data) is posted, and sent to the destination user.

A plurality of function buttons to which various functions are assigned are displayed in the upper area and the lower area of the field screen W1 (see FIG. 8). Specifically, an avatar button 31, a message button 32, a main button 33, an update button 34, a follow button 35, an item button 36, and a sort button 37 are displayed as the function buttons.

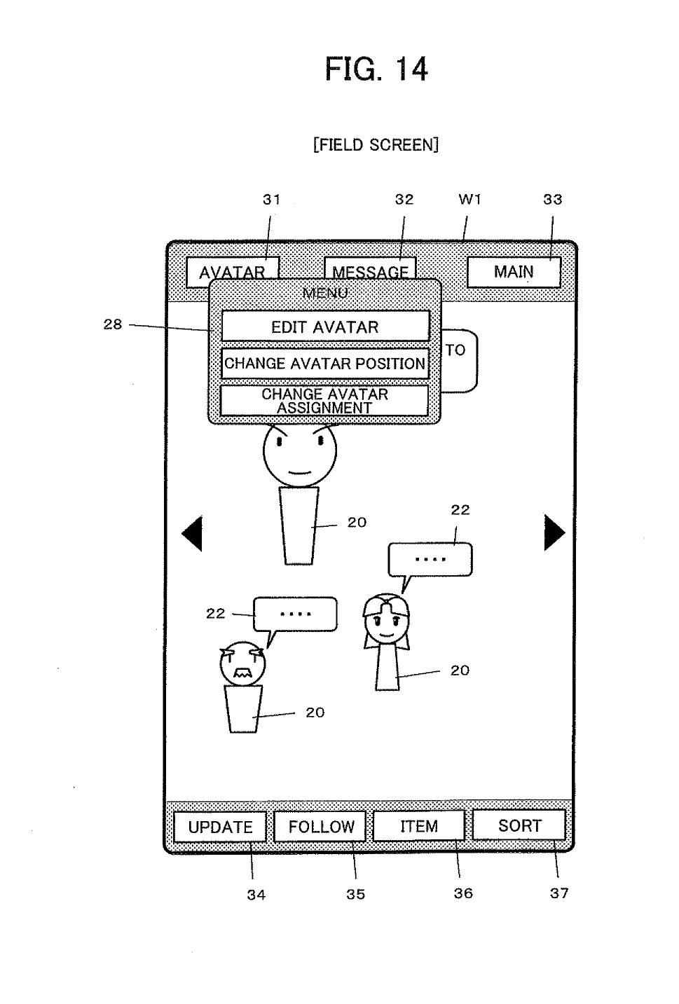

When the user has touched the avatar button 31, an avatar menu 28 (i.e., avatar operation menu) shown in FIG. 14 is displayed as a pop-up menu. An item “EDIT AVATAR” that allows the user to create a new avatar or modify the registered avatar 20, an item “CHANGE AVATAR POSITION” that allows the user to change the position of the avatar 20 in the field, an item “CHANGE AVATAR ASSIGNMENT” that allows the user to change the following user to whom the avatar 20 is assigned, are displayed within the avatar menu 28.

When the user has touched the item “EDIT AVATAR” displayed within the avatar menu 28, an item “CREATE” that allows the user to create a new avatar, and an item “MODIFY” that allows the user to modify the registered avatar are displayed. The user selects the item “CREATE” or “MODIFY”. When the user has selected the item “CREATE”, the avatar edit screen W3 (see FIG. 12) that allows the user to edit an initial avatar provided in advance is displayed. When the user has selected the item “MODIFY”, a list of the registered avatars is displayed, and the user selects the desired avatar. The avatar edit screen W3 (see FIG. 12) that allows the user to edit the selected avatar is then displayed.

When the user has touched the item “CHANGE AVATAR POSITION” displayed within the avatar menu 28, an operation that changes the position of the avatar 20 on the field screen W1 is enabled. The user moves the desired avatar 20 to the desired position by touching and sliding the avatar 20.

When the user has touched the item “CHANGE AVATAR ASSIGNMENT” displayed within the avatar menu 28, a list of the following users is displayed. A given mark that indicates whether or not the corresponding avatar 20 is disposed in the field is added to each following user. The user selects the following user for whom the user desires to dispose the avatar 20 in the field referring to the mark. Note that the number of avatars 20 that can be disposed in the field is limited (e.g., 30). The user selects the following users so that the upper limit of the number of avatars 20 is not exceeded.

When the user has touched the message button 32 displayed on the field screen W1, the message screen W4 (see FIG. 13) that allows the user to post a new message is displayed.

When the user has touched the main button 33 displayed on the field screen W1, a main screen W5 of the user is displayed.

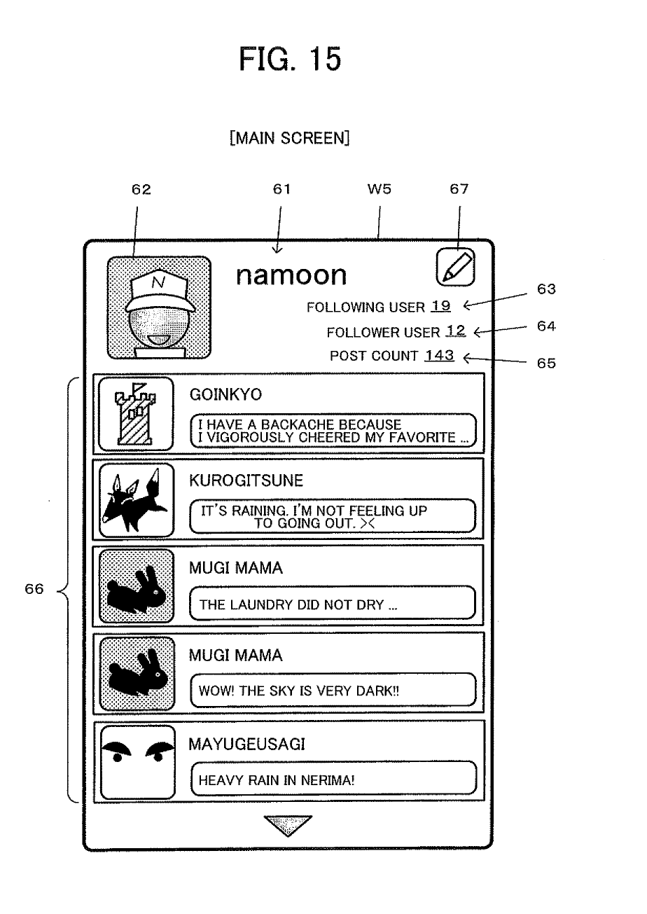

FIG. 15 is a view showing an example of the main screen W5. As shown in

FIG. 15, a user name 61, a user image 62, a following user count 63, a follower user count 64, a post count 65, and a message list 66 (i.e., the messages posted by the user and the message posted by each following user are listed in descending order of the date of post) are displayed on the main screen W5. When the user has touched one of the messages on the message list 66, the message details screen W2 (see FIG. 10) of the touched message is displayed. A message button 67 is displayed on the main screen W5. When the user has touched the message button 67, the message screen W4 (see FIG. 13) that allows the user to post a new message is displayed.

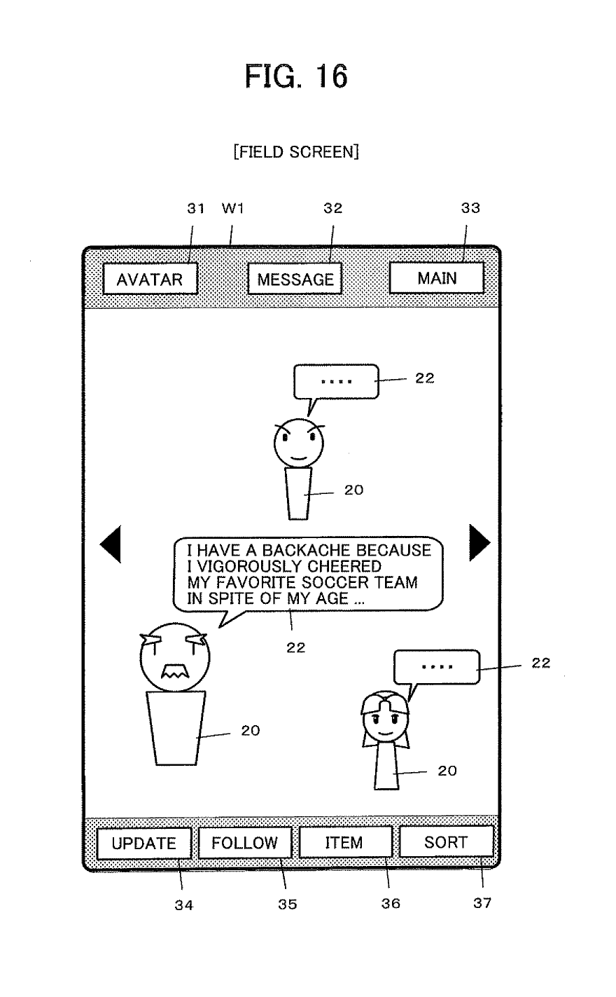

When the user has touched the update button 34 displayed on the field screen W1, the field screen W1 is updated based on the latest message of each following user (see FIG. 16).

When the user has touched the follow button 35 displayed on the field screen W1, a following user list screen W6 that shows a list of the following users is displayed.

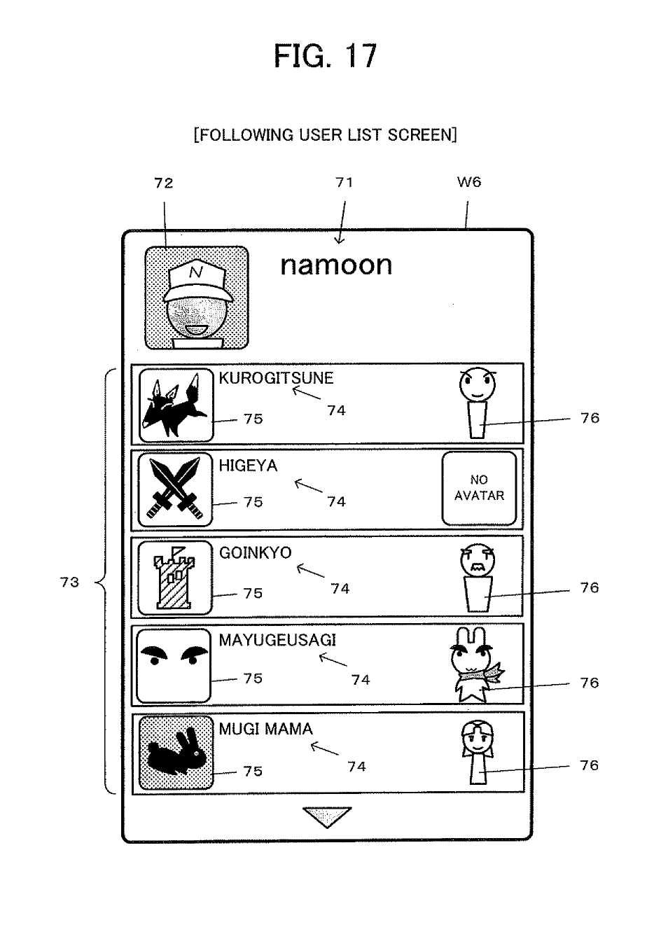

FIG. 17 is a view showing an example of the following user list screen W6. As shown in FIG. 17, a user name 71, a user image 72, and a following user list 73 are displayed on the following user list screen W6. A user name 74, a user image 75, and an avatar image 76 are displayed corresponding to each following user on the following user list 73. When the user has touched one of the following users on the following user list 73, a message list screen of the touched following user is displayed.

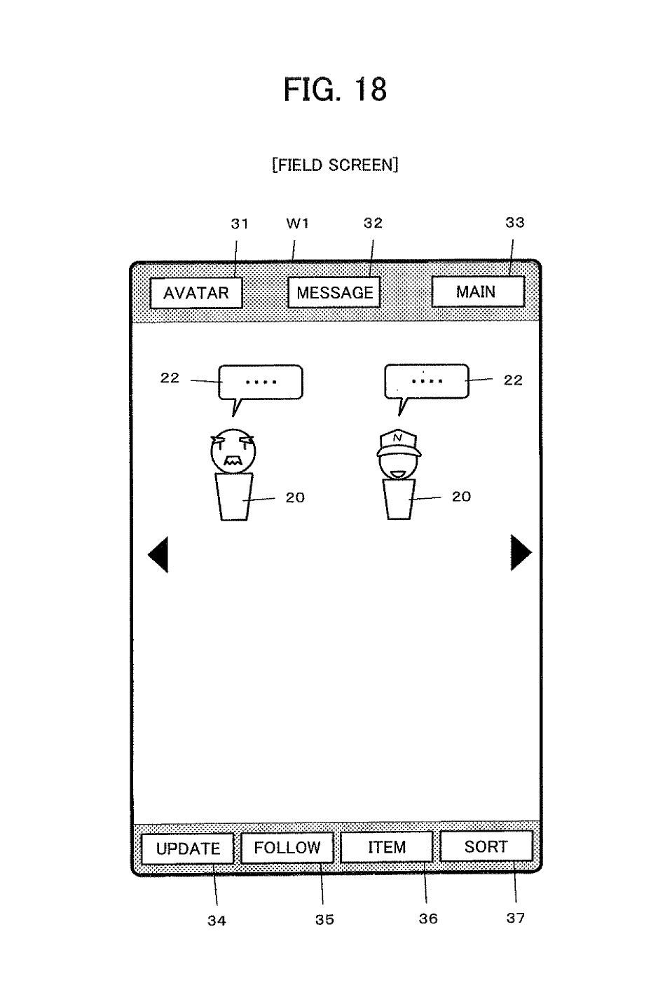

When the user has touched the sort button 37 displayed on the field screen W1, the avatars 20 are arranged in accordance with a given rule (see FIG. 18).

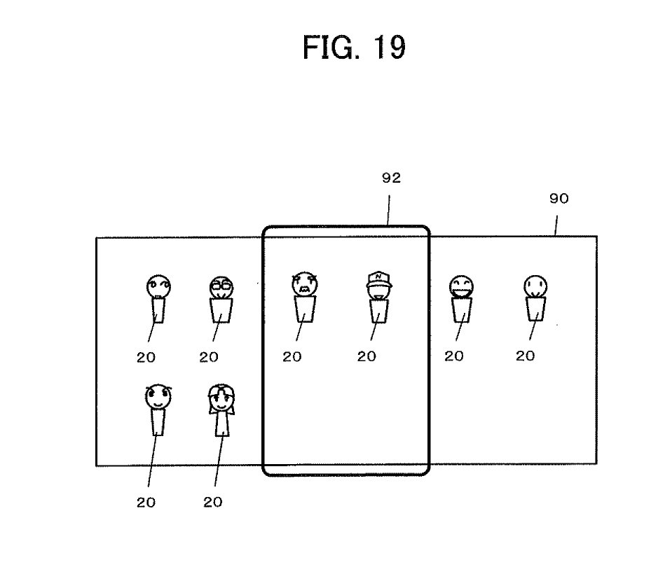

As shown in FIG. 9, only part of the field 90 is displayed on the field screen W1. As shown in FIG. 19, all of the avatars 20 disposed in the field 90 are arranged in accordance with a given rule when the user has touched the sort button 37. As shown in FIG. 18, the state of an area of the field 90 that corresponds to a display range 92 is displayed on the field screen W1.

The avatars 20 may be arranged in accordance with the latest date of post, the post count (or the post frequency (i.e., the post count within a unit period), or the content of the message. The rule may be selected by the user. When the user has selected an item “LATEST DATE OF POST” as the rule, the avatars 20 disposed in the field 90 are arranged in descending or ascending order of the date of post of the following users. When the user has selected an item “POST COUNT” as the rule, the avatars 20 disposed in the field 90 are arranged in descending or ascending order of the post count of the following users. When the user has selected an item “MESSAGE CONTENTS” as the rule, the avatars 20 disposed in the field 90 are classified into avatars for which an identical keyword is included in the message posted by the following user, and avatars for which a keyword that belongs to the same category is included in the message posted by the following user, and arranged in each group.

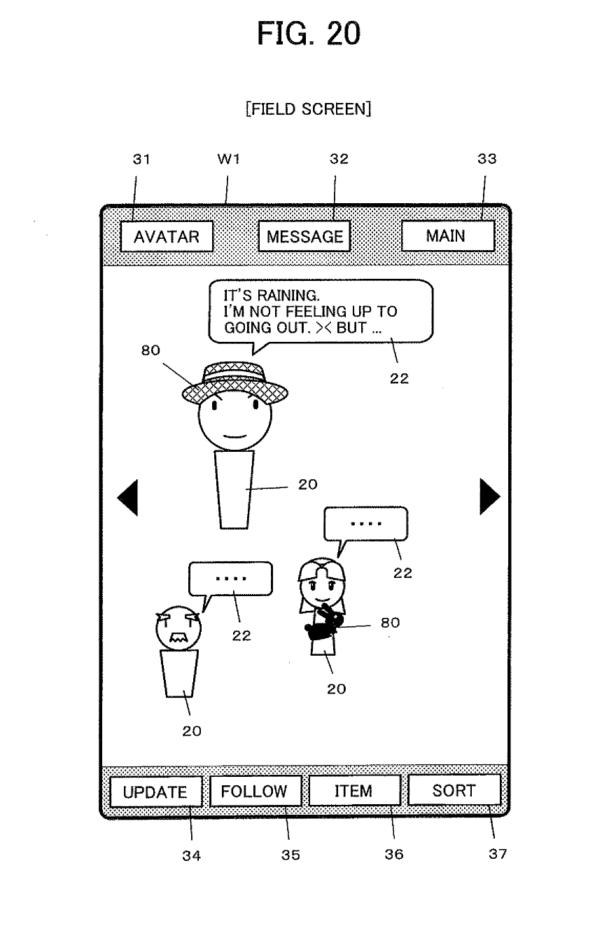

When the user has touched the item button 36 displayed on the field screen W1, a list of items that can be attached to the avatar 20 is displayed. The user selects the desired item from the list, and selects the desired following user, so that the selected item is attached to the avatar 20 corresponding to the selected following user (see FIG. 20).

FIG. 20 shows an example of the field screen W1 in which an item 80 is attached to the avatar 20. The user can obtain an item when the message posted by the user has satisfied a given item generation condition. Specifically, the user can obtain an item when a given keyword is included in his message, or the following user count or the follower user count has satisfied the condition, for example.

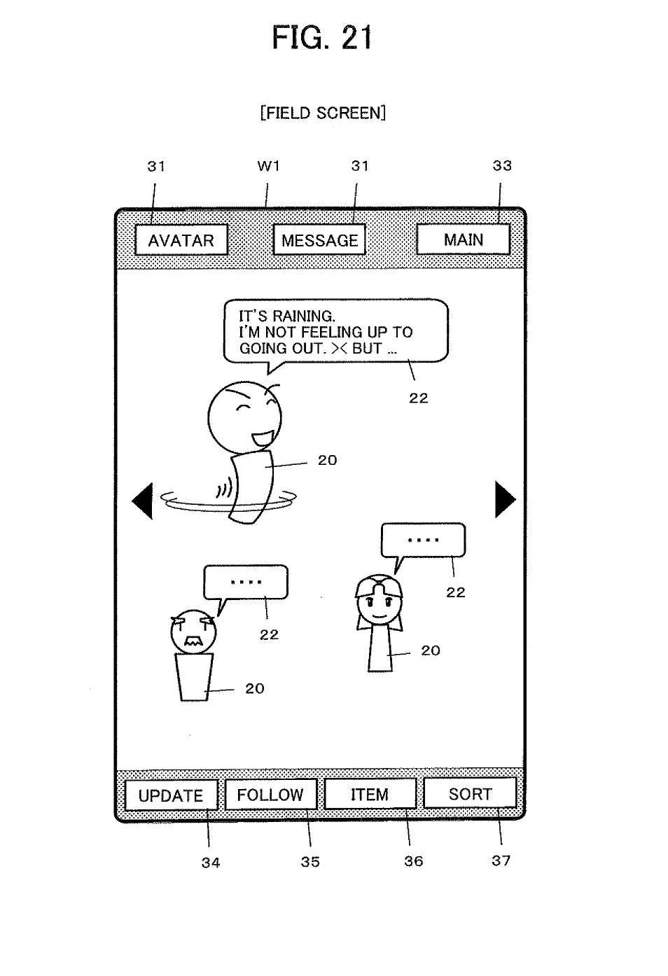

As shown in FIG. 21, the avatar 20 may make a motion on the field screen W1. FIG. 21 shows an example of the field screen W1 in which the avatar 20 makes a motion. The avatar 20 makes a motion based on the message posted by the corresponding following user. Specifically, when the message posted by the corresponding following user includes a given instruction command, the avatar 20 makes a motion corresponding to the instruction command. The user can stop the motion of the avatar 20 by touching the item “STOP MOTION” displayed within the avatar menu 26 (see FIG. 11) that is displayed when the user has touched the avatar 20. In one embodiment of the invention, the avatar 20 makes a motion, but does not change in position (i.e., does not make a movement). Note that the avatar 20 may make a motion and a movement.

Configuration

(A) Server System 1000

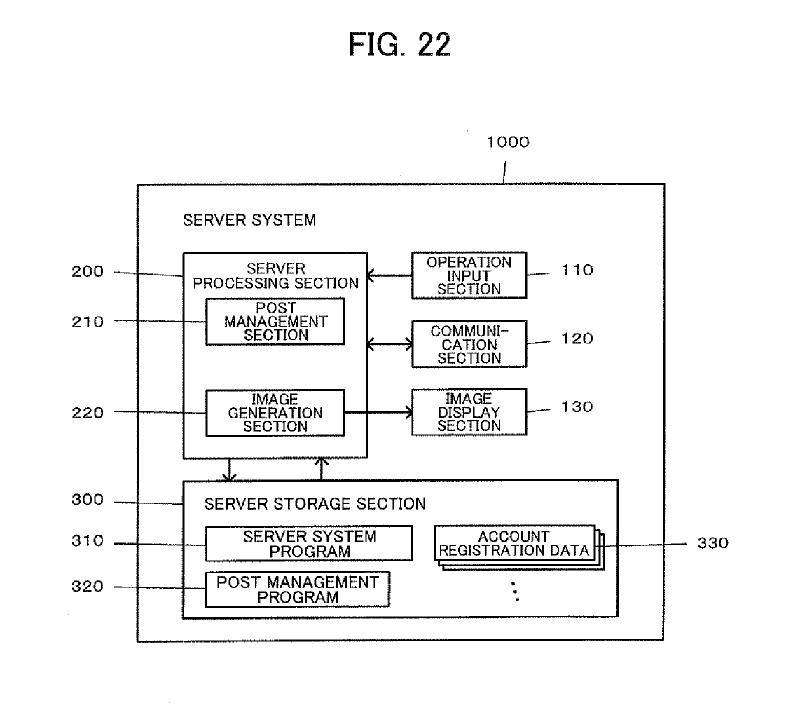

FIG. 22 is a functional configuration diagram of the server system 1000. As shown in FIG. 22, the server system 1000 includes an operation input section 110, a server processing section 200, a communication section 120, an image display section 130, and a server storage section 300.

The operation input section 110 receives an operation input performed by the administrator of the server system 1000, and outputs an operation signal corresponding to the operation input to the server processing section 200. The function of the operation input section 110 may be implemented by a keyboard, a touch pad, a trackball, or the like.

The server processing section 200 may be implemented by a microprocessor (e.g., CPU and GPU), an application-specific integrated circuit (ASIC), an IC memory, and the like. The server processing section 200 exchanges data with each functional section including the operation input section 110 and the server storage section 300. The server processing section 200 controls the operation of the server system 1000 by performing a calculation process based on a given program, data, and the operation input signal input from the operation input section 110. The server processing section 200 includes a post management section 210.

The post management section 210 manages the message posting service implemented by the user terminal 2000. Specifically, the post management section 210 registers a new account in response to a request from the user terminal 2000. Data about the registered account is stored as account registration data 330.

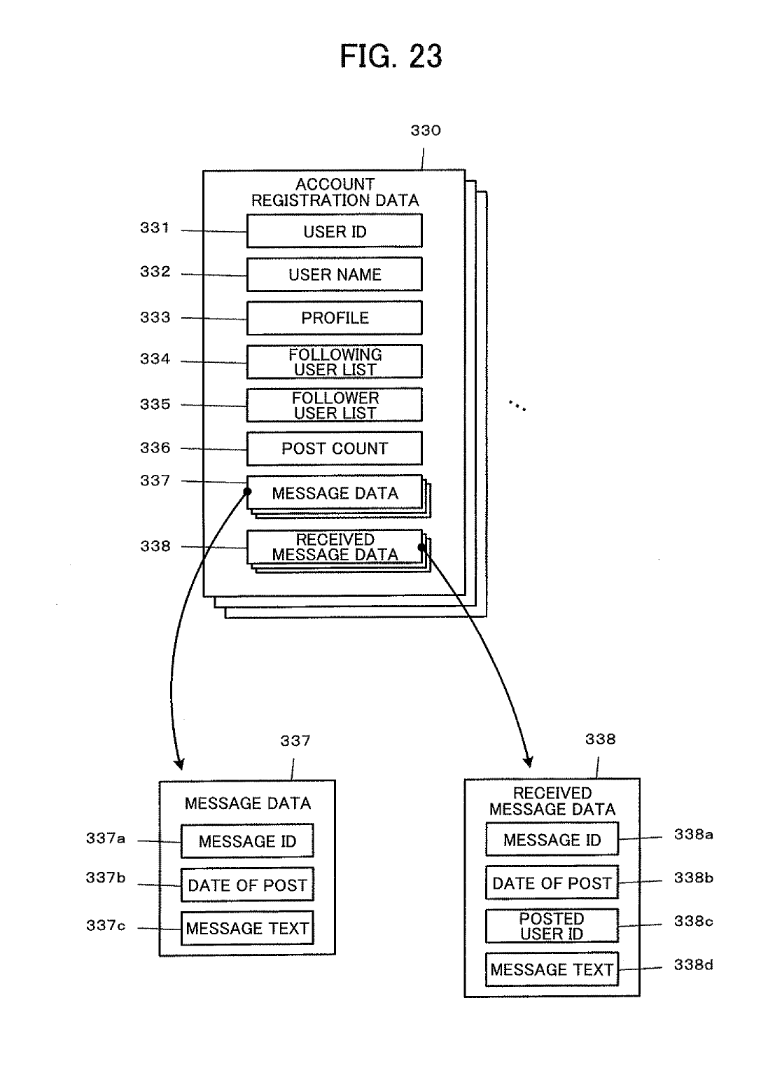

FIG. 23 is a view showing an example of the data configuration of the account registration data 330. The account registration data 330 is generated corresponding to each user who has registered an account, and includes a user ID 331, a user name 332, profile data 333, a following user list 334, a follower user list 335, a post count 336, message data 337, and received message data 338.

The message data 337 is data about the previous message posted by the user, and includes a message ID 337a, a date of post 337b, and a message text 337c. The received message data 338 is data about a direct message posted to the user (destination), and includes a message ID 338a, a date of post 338b, a posted user ID 338c, and a message text 338d.

When the post management section 210 has received an account authentication request from the user terminal 2000, the post management section 210 refers to the account registration data 330, and compares the received account information with the registered account information (authentication). When the post management section 210 has received a user data request from the authenticated user terminal 2000, the post management section 210 refers to the account registration data 330, and specifies the user based on the account information received together with the request.

The post management section 210 refers to the account registration data 330 about the specified user, and generates user data including the user name, the following user list, the follower user list, the post count, given pieces of latest message data, given pieces of latest received message data, and the like. The post management section 210 then specifies the following users referring to the account registration data 330 about the specified user. The post management section 210 then refers to the account registration data 330 about each of the specified following users, and generates following user data including the user name, the following user list, the follower user list, the post count, given pieces of latest message data, given pieces of latest received message data, and the like. The post management section 210 then transmits the generated user data and following user data to the user terminal 2000.

When the post management section 210 has received the message data transmitted from the user terminal 2000, the post management section 210 specifies the sender user based on the account information received together with the message data. The post management section 210 then adds the received message data to the message data about the specified user. When the message is a direct message, the post management section 210 specifies the name of the destination user, and adds the received message data to the received message data about the specified destination user.

The communication section 120 connects to the communication channel N to implement communication with an external device (mainly the user terminal 2000). The function of the communication section 120 may be implemented by a transceiver, a modem, a terminal adapter (TA), a router, a jack for a communication cable, a control circuit, or the like.

The image display section 130 displays a message management image based on an image signal from the server processing section 200. The function of the image display section 130 may be implemented by an image display device such as a flat panel display, a cathode-ray tube (CRT), a projector, or a head mount display.

The server storage section 300 stores a system program that implements a function of controlling the server system 1000, a game management program, data, and the like. The server storage section 300 is used as a work area for the server processing section 200, and temporarily stores the results of calculations performed by the server processing section 200 based on a program. The function of the server storage section 300 may be implemented by an IC memory (e.g., RAM or ROM), a magnetic disk (e.g., hard disk), an optical disk (e.g., CD-ROM or DVD), or the like. The server storage section 300 stores a server system program 310, a post management program 320, and the account registration data 330.

The server system program 310 is a system program that causes the server processing section 200 to implement a basic input/output function necessary for the server system 1000. The post management program 320 is a program that causes the server processing section 200 to implement the function of the post management section 210.

(B) User Terminal 2000

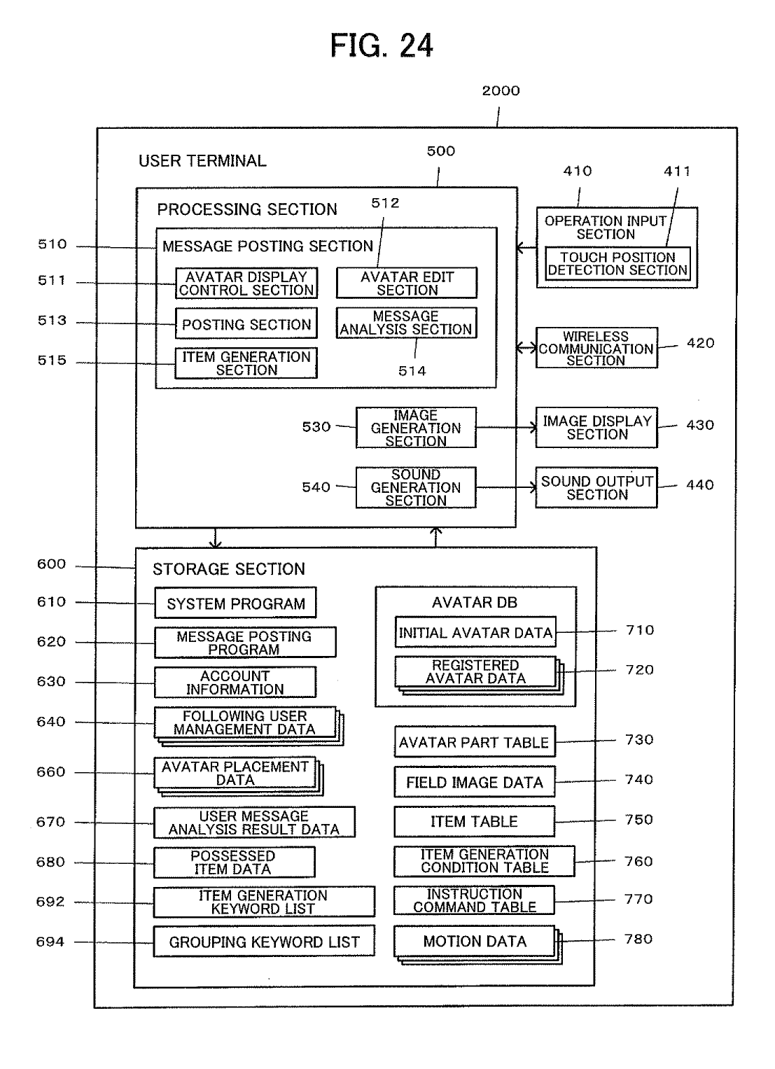

FIG, 24 is a functional configuration diagram of the user terminal 2000. As shown in FIG. 24, the user terminal 2000 includes an operation input section 410, a processing section 500, an image display section 430, a sound output section 440, a wireless communication section 420, and a storage section 600.

The operation input section 410 receives an operation input performed by the user, and outputs an operation signal corresponding to the operation input to the processing section 500. The function of the operation input section 410 may be implemented by a button switch, a joystick, a touch pad, a trackball, or the like. In FIG. 2, the operation key 2006 corresponds to the operation input section 410. The operation input section 410 includes a touch position detection section 411 that detects a touch position on a display screen. In FIG. 2, the touch panel 2010 corresponds to the touch position detection section 411.

The processing section 500 may be implemented by a microprocessor (e.g., CPU and GPU), an application-specific integrated circuit (ASIC), an IC memory, and the like. The processing section 500 exchanges data with each functional section of the user terminal 2000. The processing section 500 controls the operation of the user terminal 2000 by performing a calculation process based on a given program, data, the operation signal input from the operation input section 410, and the like. In FIG. 2, the control device 2012 corresponds to the processing section 500. The processing section 500 includes a message posting section 510, an image generation section 530, and a sound generation section 540.

The message posting section 510 includes an avatar display control section 511, an avatar edit section 512, a posting section 513, a message analysis section 514, and an item generation section 515. The message posting section 510 causes the user terminal 2000 to implement the message posting service provided by the server system 1000.

The avatar display control section 511 displays the field screen W1 (see FIG. 8) that includes the avatar of each following user on the image display section 430, Specifically, the avatar display control section 511 refers to following user management data 640, and specifies the following user for whom the avatar 20 is disposed in the field. The avatar display control section 511 then displays the field screen W1 in which the avatar 20 corresponding to each of the specified following users is disposed in the field. When the item 80 is set corresponding to the avatar 20 disposed in the field, the avatar display control section 511 also displays the item 80. When there is an instruction command that has not been executed, the avatar display control section 511 causes the avatar 20 to make a motion corresponding to the instruction command.

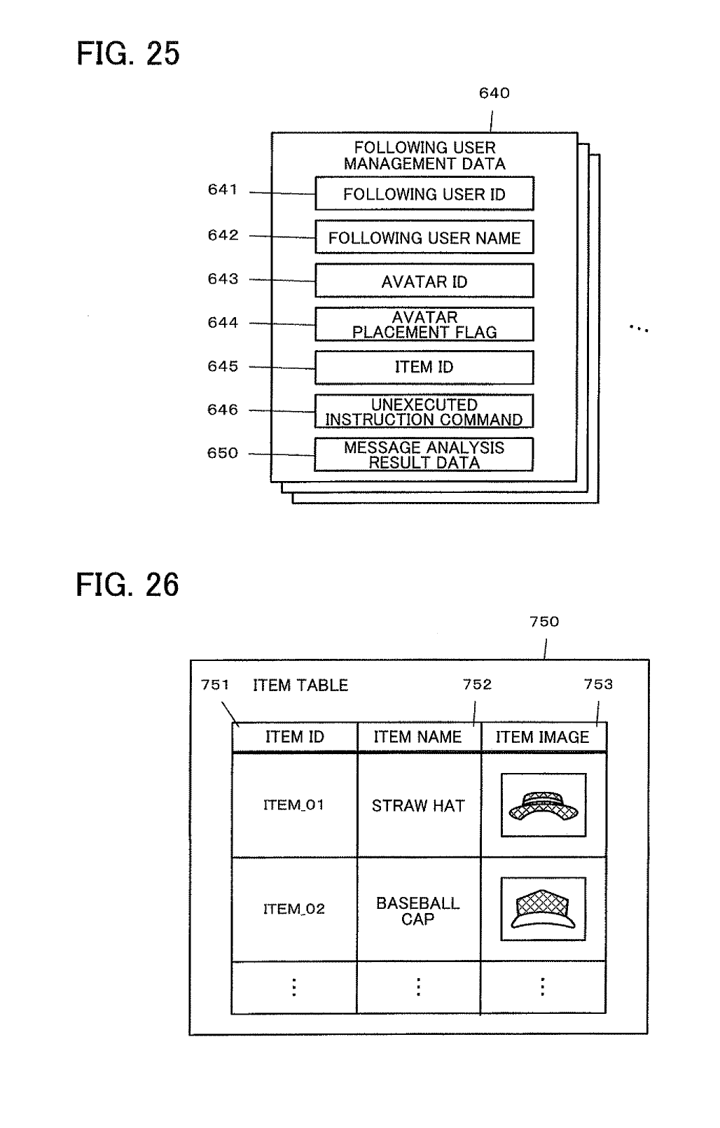

The following user management data 640 is used to display (control) the avatar 20 corresponding to each following user. FIG. 25 is a view showing an example of the data configuration of the following user management data 640. The following user management data 640 is generated corresponding to each following user, and includes a user ID 641, a user name 642, an avatar ID 643, an avatar placement flag 644, an item ID 645, an unexecuted instruction command 646, and message analysis result data 650, as shown in FIG. 25.

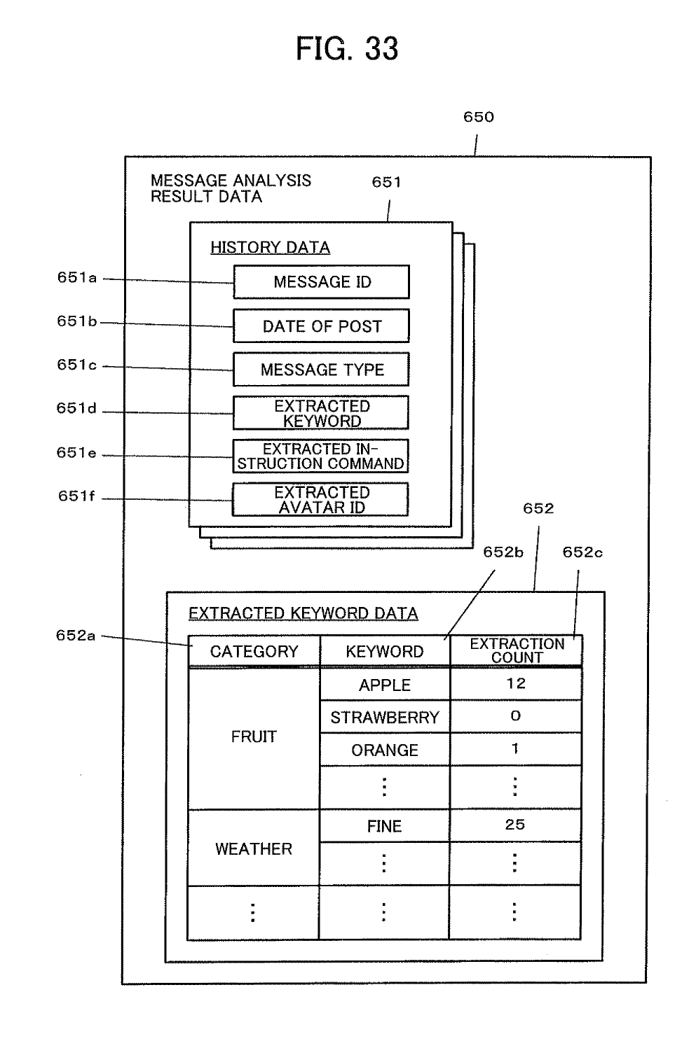

The avatar placement flag 644 indicates whether or not to dispose the avatar 20 in the field. The unexecuted instruction command 646 is an instruction command that causes the avatar 20 to make a given motion, and has not been executed. The unexecuted instruction command 646 is added based on the analysis result of the message posted by the following user obtained by the message analysis section 514. The message analysis result data 650 indicates the analysis result of the message posted by the following user obtained by the message analysis section 514 (details thereof are described later (see FIG. 33)).

The item 80 is added to the avatar 20 by superimposing an image of the item on an image of the avatar. An image of each item is stored in an item table 750.

FIG. 26 shows an example of the data configuration of the item table 750. As shown in FIG. 26, the item table 750 stores an item ID 751, an item name 752, and an item image 753.

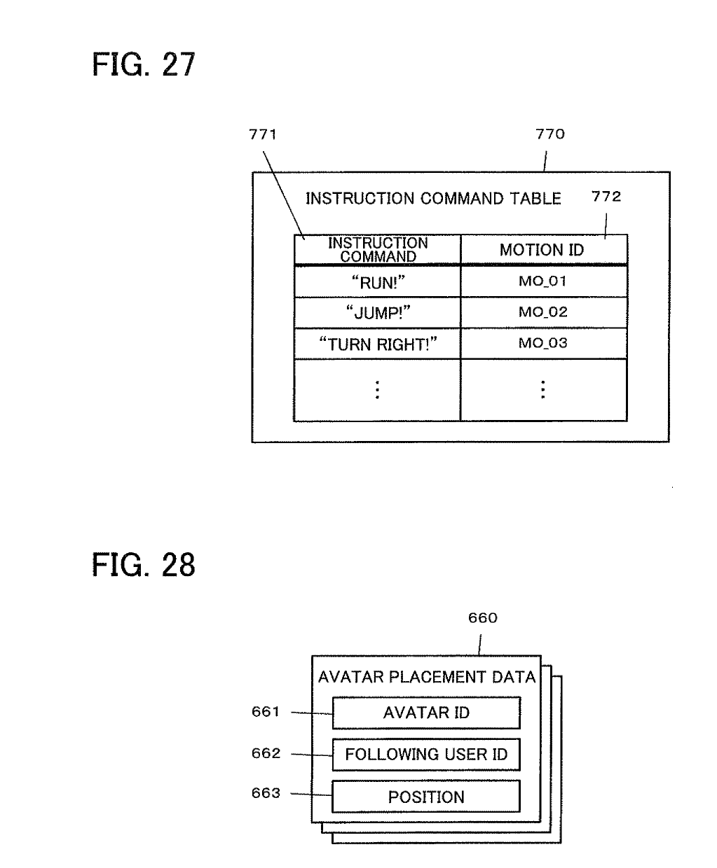

The relationship between the instruction command and the motion is stored in an instruction command table 770. FIG. 27 shows an example of the data configuration of the instruction command table 770. As shown in FIG. 27, the instruction command table 770 stores an instruction command 771 and a motion ID 772.

The data about the avatar 20 disposed in the field is stored as avatar placement data 660. FIG. 28 is a view showing an example of the data configuration of the avatar placement data 660. As shown in FIG. 28, the avatar placement data 660 includes an avatar ID 661, a following user ID 662, and a position 663 of each avatar 20 currently disposed in the field 90.

The avatar display control section 511 groups the avatars 20 based on the message analysis results obtained by the message analysis section 514, and displays the avatars 20 belonging to each group in a row. Specifically, the avatar display control section 511 refers to the avatar placement data 660, and specifies the following users for whom the avatar 20 is disposed in the field. The avatar display control section 511 then groups the specified following users based on a given grouping keyword included in the messages posted by the following users, and disposes the avatar 20 of each following user at a given position specified for each group.

More specifically, the grouping keywords are classified into a plurality of categories. The avatar display control section 511 calculates the total extraction count of each keyword corresponding to each following user, and determines the category for which the extraction count is a maximum to be the category to which the following user belongs. The avatar display control section 511 then groups the following users corresponding to each category.

The grouping keyword included in the message posted by each following user is extracted by the message analysis section 514, and stored as the message analysis result data 650 (see FIG. 33).

The avatar edit section 512 creates and modifies the avatar 20. Specifically, the avatar edit section 512 displays the avatar edit screen W3 (see FIG. 12) that allows the user to edit the initial avatar, creates a new avatar by modifying the initial avatar based on an operation performed by the user, and registers the created avatar as a new avatar. The avatar edit section 512 displays the avatar edit screen W3 that allows the user to edit the registered avatar, modifies the registered avatar based on an operation performed by the user, and updates the registered avatar with the modified avatar.

Note that the data about the initial avatar is stored as initial avatar data 710, and the data about each registered avatar is stored (registered) as registered avatar data 720. The initial avatar data 710 and the registered avatar data 720 have an identical data configuration. The initial avatar 20 includes only the basic parts (i.e., parts other than the basic parts are not set).

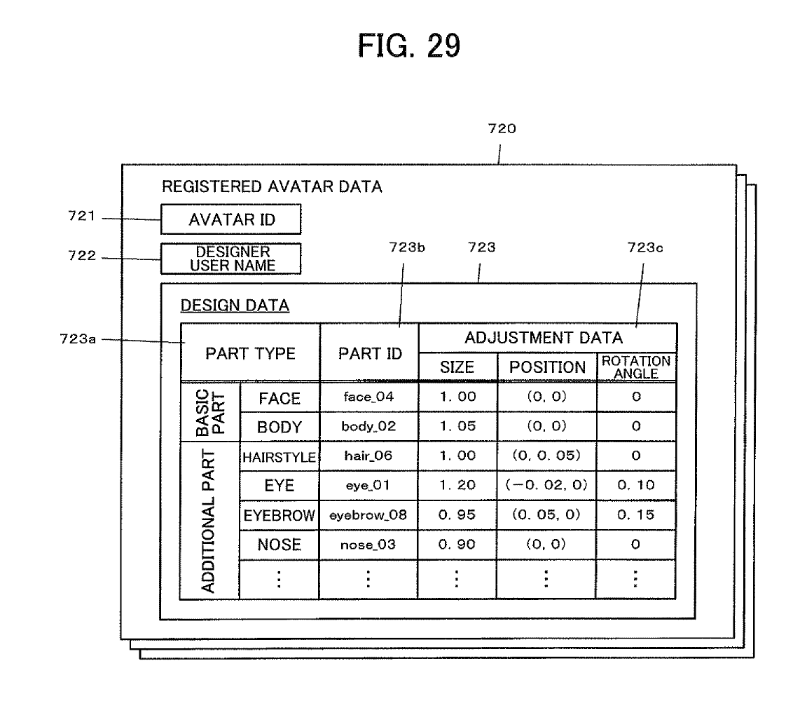

FIG. 29 shows an example of the data configuration of the registered avatar data 720. The registered avatar data 720 is generated corresponding to each registered avatar, and includes an avatar ID 721, a designer user name 722, and design data 723, as shown in FIG. 29. The designer user name 722 is the name of the final user who has modified (created) the avatar.

The design data 723 is data about the details of each part of the avatar, and includes a part 723a, a part ID 723b, and adjustment data 723c. The adjustment data 723c indicates the degree of adjustment of the basic value (size, position, and rotation angle) of each part. The degree of adjustment of the size refers to the expansion/reduction ratio with respect to the basic size. The degree of adjustment of the position refers to the difference from the basic position in the X-axis direction and the Y-axis direction. The degree of adjustment of the rotation angle refers to the rotation angle with respect to the basic direction.

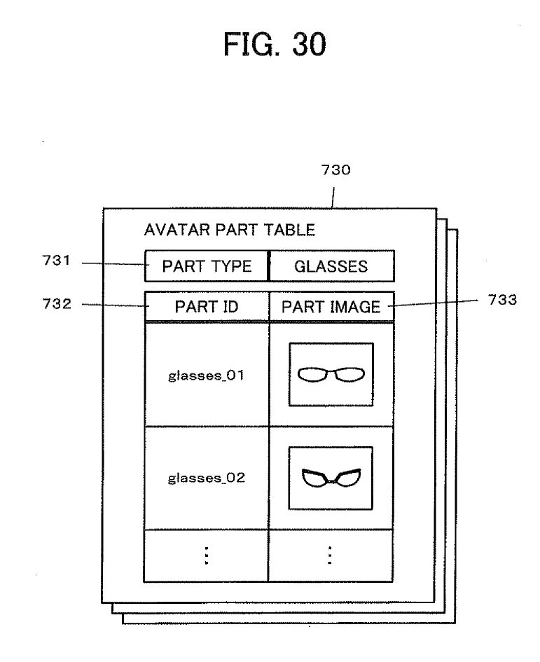

The data about each part of the avatar 20 is stored in an avatar part table 730. FIG. 30 shows an example of the data configuration of the avatar part table 730. The avatar part table 730 is generated corresponding to each part type 731, and includes a part ID 732 and a part image 733, as shown in FIG. 30.

The posting section 513 posts a message based on an operation performed by the user. Specifically, the posting section 513 displays the message screen W4 (see FIG. 13) that allows the user to input a message, and inputs a text message based on an operation performed by the user. The posting section 513 inputs a given identifier and the name of the destination user to the input area 47 displayed on the message screen W4 when the message is a direct message, and inputs a quoted message to the input area 47 when the message is a quote message.

When the posting section 513 also posts the avatar 20, the posting section 513 incorporates avatar data based on the design data 723 about the avatar 20 in the message. The avatar data is data in which the parameters (part ID and adjustment data) included in the design data 723 about the avatar are arranged in the specified order. When the posting section 513 also posts the instruction command, the posting section 513 incorporates the instruction command in the message. When the user has issued a post instruction, the posting section 513 transmits the input message to the server system 1000 as message data.

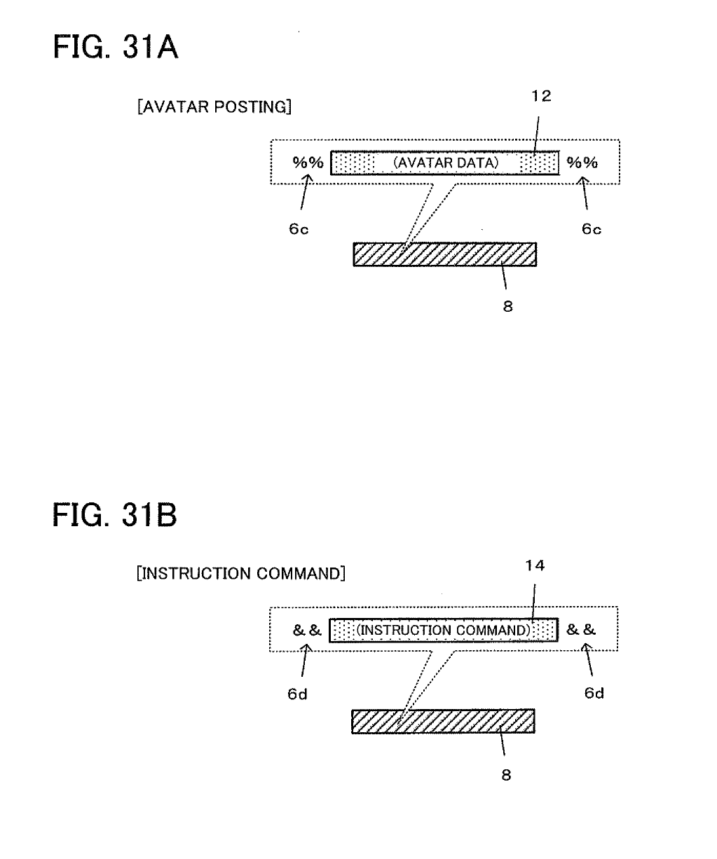

FIGS. 31A and 31B are views showing the format of a message to be posted. FIG. 31A shows the format of a message when posting the avatar, and FIG. 31B shows the format of a message when posting the instruction command. Avatar data 12 or an instruction command 14 is incorporated in a message 8 input by the user. As shown in FIG. 31A, a given identifier 6c (two symbols “%” in FIG. 31A) that indicates the avatar data is added at the beginning and the end of the avatar data 12. As shown in FIG. 31B, a given identifier 6d (two symbols “&” in FIG. 31B) that indicates the instruction command is added at the beginning and the end of the instruction command 14.

The message analysis section 514 analyzes the messages posted by the user and each following user. Specifically, the message analysis section 514 analyzes the message posted by the posting section 513 (i.e., the message posted by the user). Specifically, the message analysis section 514 determines whether or not the message data includes a given item generation keyword, and extracts the keyword included in the message data. The item generation keyword is a keyword by which an item set to the avatar 20 is generated, and is stored in an item generation keyword list 692.

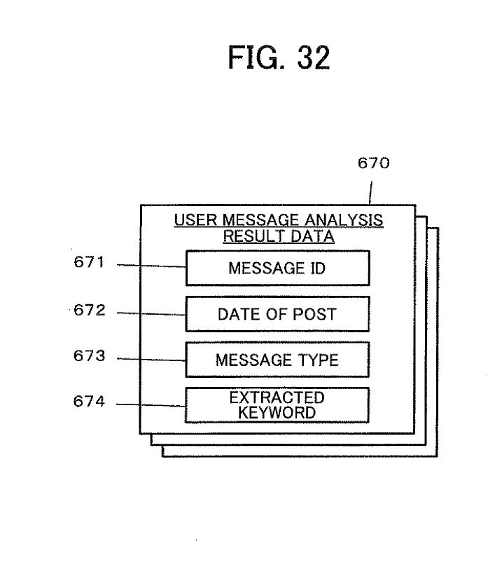

The analysis result for the message posted by the user is stored as user message analysis result data 670. FIG. 32 is a view showing an example of the data configuration of the user message analysis result data 670. The user message analysis result data 670 is generated corresponding to each message posted by the user, and includes a message ID 671, a date of post 672, a message type 673, and an extracted keyword 674, as shown in FIG. 32.

The message analysis section 514 analyzes the message posted by each following user and acquired from the server system 1000. Specifically, the message analysis section 514 determines whether or not each message data includes a given grouping keyword, avatar design data, and a given instruction command, and extracts the keyword, the avatar design data, and the instruction command included in the message data.

When the message analysis section 514 has extracted the avatar design data, the message analysis section 514 registers an avatar based on the design data. When the message analysis section 514 has extracted the instruction command, the message analysis section 514 adds the instruction command as the unexecuted instruction command of the following user.

The grouping keyword is a keyword used when grouping the following users based on their messages, and is stored (categorized) in a grouping keyword list 694. The instruction command is a command that causes the avatar to make a motion, and is defined (stored) in an instruction command table 770.

The analysis result for the message posted by each following user is stored as the message analysis result data 650 included in the following user management data 640 about each following user.

FIG. 33 is a view showing an example of the data configuration of the message analysis result data 650. As shown in FIG. 33, the message analysis result data 650 includes history data 651 and extracted keyword data 652 about each analyzed message. The history data 651 includes a message ID 651a, a date of post 651b, a message type 651c, an extracted keyword 651d, an extracted instruction command 651e, and an avatar ID 651 f of the extracted avatar design data. The extracted keyword data 652 includes a predetermined category 652a, a keyword 652b that belongs to the category, and an extraction count 652c.

The item generation section 515 generates an item corresponding to a given item generation condition when the item generation condition has been satisfied, and adds the generated item to the items possessed by the user. The items possessed by the user can be set to the avatar corresponding to the following user. The items possessed by the user are stored as possessed item data 680.

The item generation condition includes (1) the post count (or the post frequency (i.e., the post count within a unit period), (2) the follower user count, and (3) a keyword included in the message data, and is defined in an item generation condition table 760.

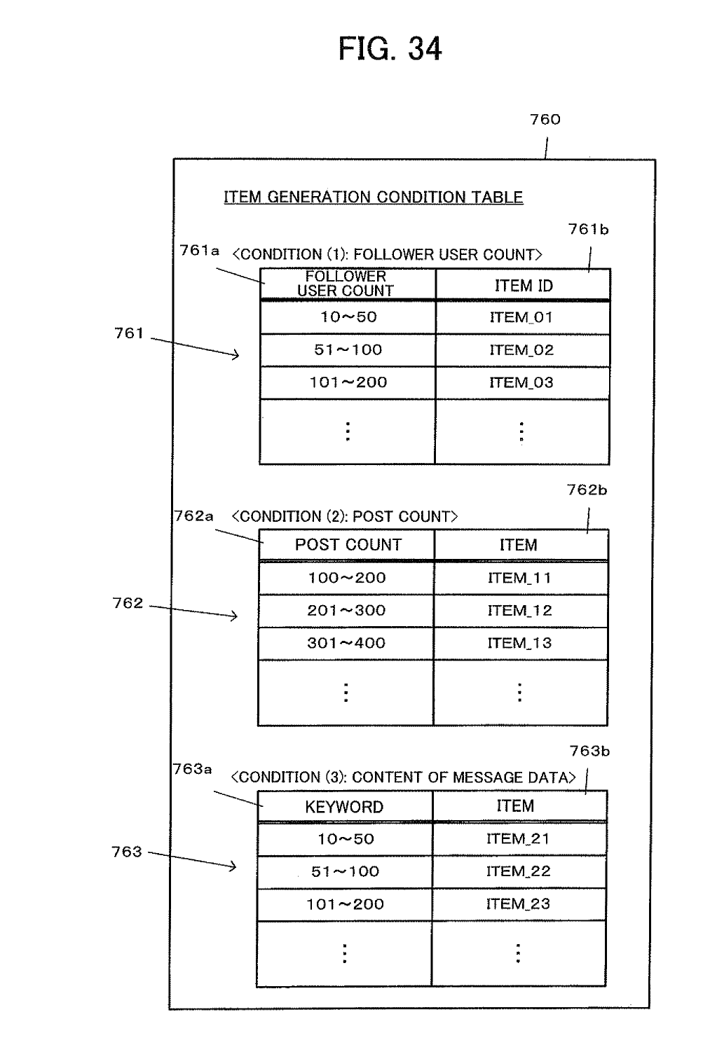

FIG. 34 shows an example of the data configuration of the item generation condition table 760. As shown in FIG. 34, the item generation condition table 760 includes condition tables 761, 762, and 763 that differ in item generation condition. The condition table 761 includes a follower user count 761a (i.e., item generation condition), and an item 761b to be generated. The condition table 762 includes a post count 762a (i.e., item generation condition), and an item 762b to be generated. The condition table 763 includes a keyword 763a (i.e., item generation condition), and an item 763b to be generated.

Note that an item is generated only once when each item generation condition has been satisfied (i.e., an item is generated when each item generation condition has been satisfied for the first time).

Specifically, when the user data has been acquired from the server system 1000, the item generation section 515 generates an item when the post count or the follower user count included in the user data has satisfied the item generation condition referring to the condition tables 761 and 762. When the posting section 513 has posted a message, the item generation section 515 generates an item when the item generation keyword included in the message data posted by the user and extracted by the message analysis section 514 has satisfied the item generation condition referring to the condition table 763.

Again referring to FIG. 24, the image generation section 530 generates a display image every frame (e.g., 1/60th of a second) based on the processing result of the avatar display control section 511, and outputs image signals of the generated display image to the image display section 430. The function of the image generation section 530 may be implemented by a processor (e.g., graphics processing unit (GPU) or a digital signal processor (DSP)), a video signal IC, a video codec, a drawing frame IC memory (e.g., frame buffer), and the like.

The image display section 430 displays an image based on the image signals input from the image generation section 530. The function of the image display section 430 may be implemented by an image display device such as a flat panel display or a cathode-ray tube (CRT), for example. In FIG. 2, the liquid crystal display 2008 corresponds to the image display section 430.

The sound generation section 540 generates sound signals (e.g., effect sound, BGM, and operation sound)based on the results of processing performed by the avatar display control section 511, and outputs the generated sound signals to the sound output section 440. The function of the sound generation section 540 may be implemented by a processor (e.g., digital signal processor (DSP) or sound synthesis IC) or an audio codec that can reproduce a sound file, for example.

The sound output section 440 outputs sound (e.g., effect sound and BGM) based on the sound signals input from the sound generation section 540. In FIG. 2, the speaker 2002 corresponds to the sound output section 440.

The communication section 420 connects to the communication channel N to implement communication with an external device (mainly the server system 1000). The function of the communication section 420 may be implemented by a transceiver, a modem, a terminal adapter (TA), a jack for a communication cable, a control circuit, or the like. In FIG. 2, the wireless communication device included in the control device 2012 corresponds to the communication section 420.

The storage section 600 stores a system program that causes the processing section 500 to control the user terminal 2000, an application program, data, and the like. The storage section 600 is used as a work area for the processing section 500, and temporarily stores the results of calculations performed by the processing section 500 based on a program, data input from the operation section 410, and the like. The function of the storage section 600 may be implemented by an IC memory (e.g., RAM or ROM), a magnetic disk (e.g., hard disk), an optical disk (e.g., CD-ROM or DVD), or the like. In FIG. 2, the IC memory included in the control device 2012 or the memory card 2020 corresponds to the storage section 600.

The storage section 600 stores a system program 610, a message posting program 620, the account information 630, the following user management data 640, the avatar placement data 660, the user message analysis result data 670, the possessed item data 680, the item generation keyword list 692, the grouping keyword list 694, the avatar DB including the initial avatar data 710 and the registered avatar data 720, the avatar part table 730, the field image data 740, the item table 750, the item generation condition table 760, the instruction command table 770, and the motion data 780.

The system program 610 is a program that causes the processing section 500 to implement a basic input/output function necessary for the user terminal 2000. The message posting program 620 is a program that causes the processing section 500 to implement the function of the message posting section 510.

Process Flow

(A) Server System 1000

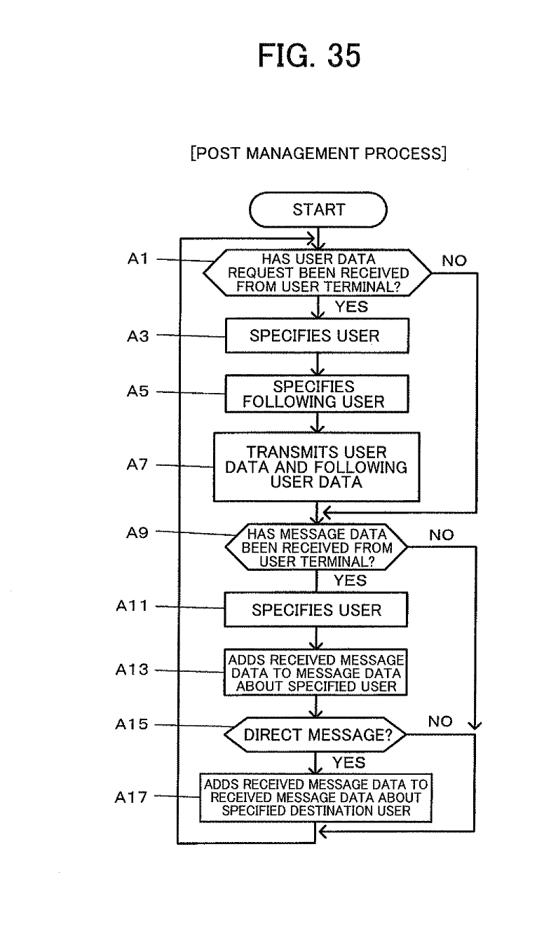

FIG. 35 is a flowchart illustrating the flow of a post management process performed by the post management section 210 included in the server system 1000. As shown in FIG. 35, when the post management section 210 has received a user data request from the user terminal 2000 (step A1: YES), the post management section 210 refers to the account registration data 330, and specifies the user based on the account information received together with the request (step A3). The post management section 210 then specifies the following users referring to the account registration data 330 about the specified user (step A5).

The post management section 210 then generates user data referring to the account registration data 330 about the specified user. The post management section 210 also generates following user data referring to the account registration data 330 about each following user who follows the specified user. The post management section 210 then transmits the generated user data and following user data to the user terminal 2000 (step A7).

When the post management section 210 has received message data from the user terminal 2000 (step A9: YES), the post management section 210 refers to the account registration data 330, and specifies the sender user based on the account information received together with the message data (step A11). The post management section 210 then adds the received message data to the message data about the specified user (step A13). When the message is a direct message (step A15: YES), the post management section 210 specifies the destination user, and adds the received message data to the received message data about the specified destination user (step A17). The post management section 210 then returns to the step A1. The post management process is thus completed.

(B) User Terminal 2000

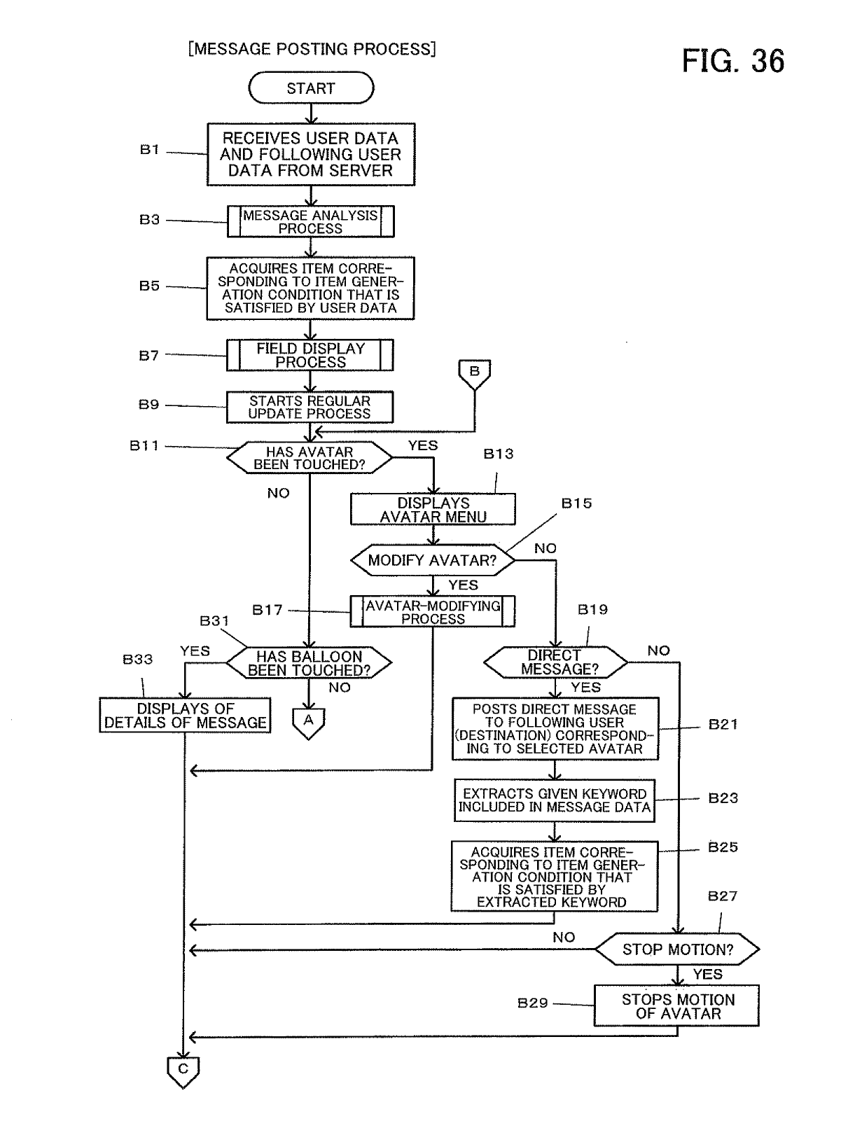

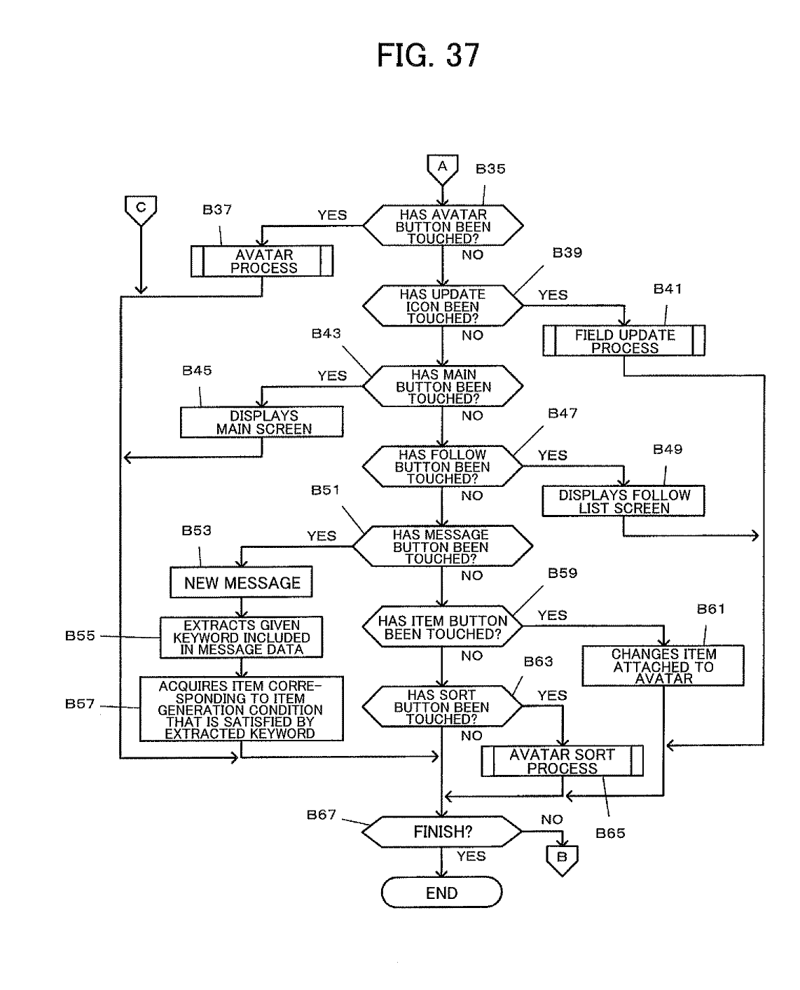

FIGS. 36 and 37 are flowcharts illustrating the flow of a message posting process performed by the message posting section 510 included in the user terminal 2000. As shown in FIG. 36, the message posting section 510 receives the user data and the following user data from the server system 1000 (step B1). The message analysis section 514 then performs a message analysis process on the acquired following user data (step B3).

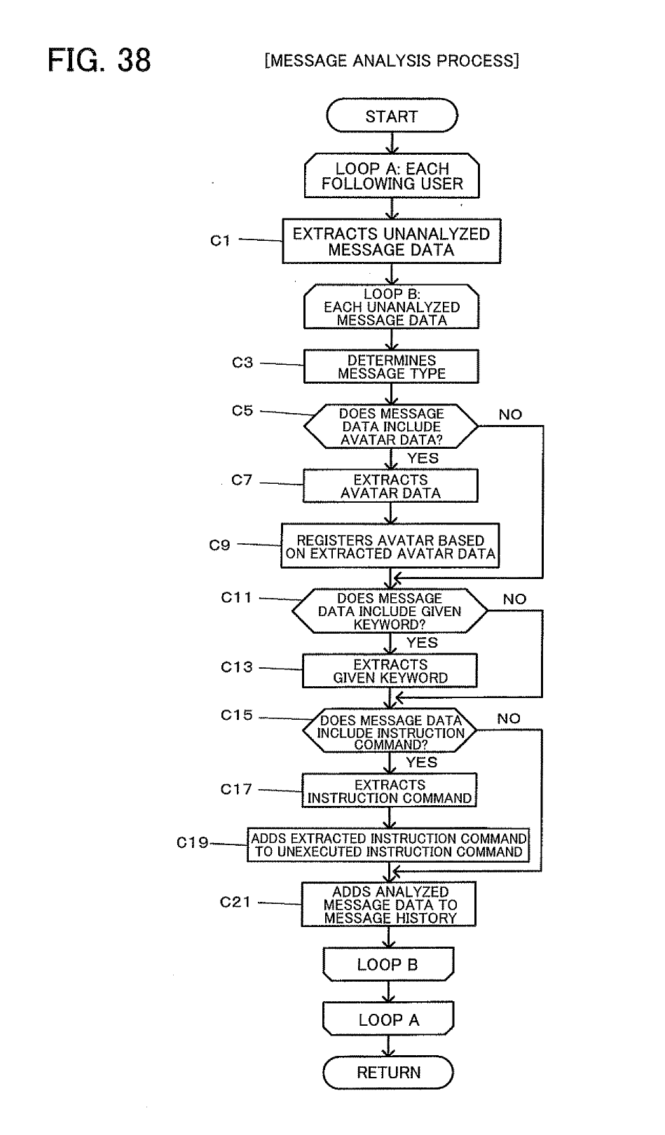

FIG. 38 is a flowchart illustrating the flow of the message analysis process. As shown in FIG. 38, the message analysis section 514 performs a loop A process on each following user.

In the loop A process, the message analysis section 514 extracts unanalyzed message data from the message data included in the following user data about the target following user and received from the server system 1000 (step C1). The message analysis section 514 then performs a loop B process on each of the extracted unanalyzed message data.

In the loop B, the message analysis section 514 specifies the message type of the target message data (step C3). The message analysis section 514 determines whether or not the message data includes the avatar design data. When the message data includes the avatar design data (step C5: YES), the message analysis section 514 extracts the avatar design data (step C7), and generates (registers) an avatar based on the design data (step C9).

The message analysis section 514 also determines whether or not the message data includes a given grouping keyword. When the message data includes a given grouping keyword (step C11: YES), the message analysis section 514 extracts the keyword included in the message data (step C13).

The message analysis section 514 also determines whether or not the message data includes a given instruction command. When the message data includes a given instruction command (step C15: YES), the message analysis section 514 extracts the instruction command (step C17), and determines the extracted instruction command to be an unexecuted instruction command of the following user (step C19).

The message analysis section 514 then adds the analyzed message data to the message history of the following user (step C21). The loop B process is thus completed.

When the loop B process has been performed on all of the unanalyzed message data, the loop A process on the target following user ends. When the loop A process has been performed on all of the following users, the message analysis process ends.

The item generation section 515 then determines whether or not the item generation condition has been satisfied based on the latest user data. When the item generation condition has been satisfied, the item generation section 515 determines that the user has acquired the item corresponding to the item generation condition, and adds the item to the items possessed by the user (step B5).

The avatar display control section 511 then performs a field display process to display the field screen W1 (step B9).

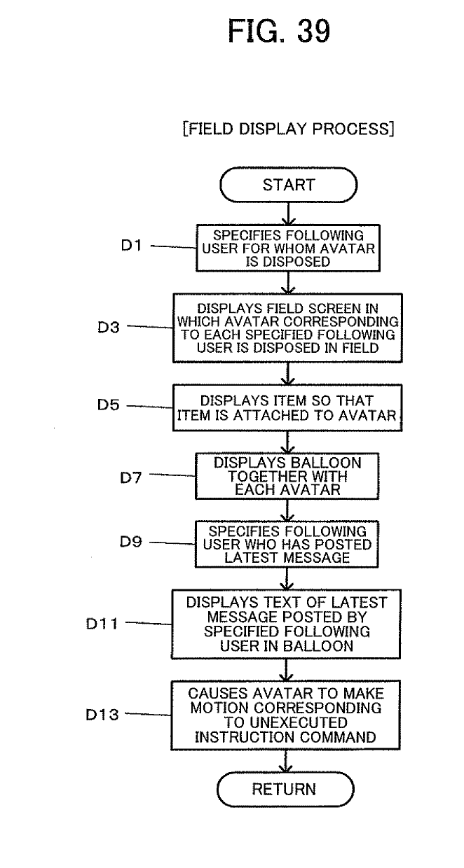

FIG. 39 is a flowchart illustrating the flow of the field display process. As shown in FIG. 39, the avatar display control section 511 specifies the following users (avatar-placement-target following users) for whom the avatar 20 is disposed in the field (step D1). The avatar display control section 511 then displays the field screen W1 in which the avatar 20 corresponding to each of the specified avatar-placement-target following users is disposed in the field (step D3).

The avatar display control section 511 then determines whether or not an item attached to the avatar has been set to each of the avatar-placement-target following users. When an item attached to the avatar has been set, the avatar display control section 511 displays the item so that the item is attached to the avatar 20 (step D5). The avatar display control section 511 also displays the balloon 22 together with each avatar 20 (step D7). The avatar display control section 511 then specifies the following user who has posted the latest message from the avatar-placement-target following users (step D9). The avatar display control section 511 enlarges the avatar 20 and the balloon 22 corresponding to the specified following user, and displays a text of the latest message posted by the specified following user in the balloon 22 (step D11).

The avatar display control section 511 then determines the presence or absence of an unexecuted instruction command corresponding to each of the avatar-placement-target following users. When an unexecuted instruction command is present, the avatar display control section 511 causes the avatar corresponding to the following user to make a motion corresponding to the unexecuted instruction command (step D13). The field display process is thus completed.

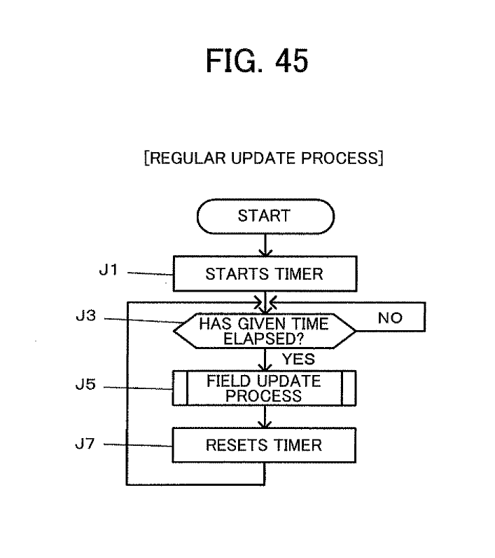

A regular update process (see FIG. 45) is then performed (step 139).

When the user has touched the avatar 20 displayed on the field screen W1 (step B11: YES), the avatar menu 26 corresponding to the avatar 20 is displayed (step B13). When the user has touched the item “MODIFY AVATAR” displayed within the avatar menu 26 (step B15: YES), the avatar edit section 512 performs an avatar-modifying process on the selected avatar 20 (step B17).

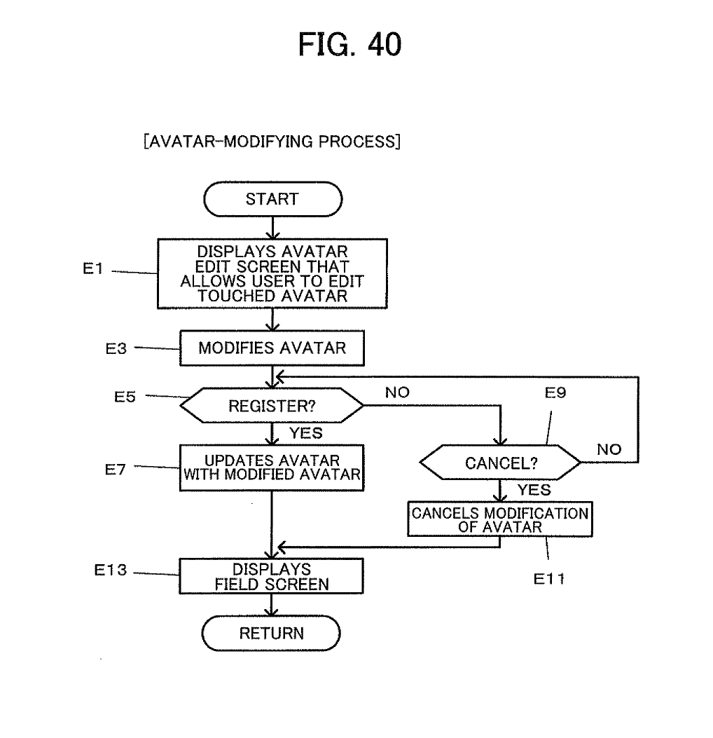

FIG. 40 is a flowchart illustrating the flow of the avatar-modifying process. As shown in FIG. 40, the avatar edit section 512 displays the avatar edit screen W3 that allows the user to edit the avatar 20 (step El). The avatar edit section 512 then modifies the avatar 20 based on an operation performed by the user (step E3).

When the user has touched the item “REGISTER (OK)” (step E5: YES), the avatar edit section 512 updates the avatar 20 with the modified avatar (step E7). When the user has touched the item “CANCEL” (step E9: YES), the avatar edit section 512 cancels modification of the avatar (step E11). The avatar edit section 512 then displays the field screen W1 (step E13). The avatar-modifying process is thus completed.

When the user has touched the item “DIRECT MESSAGE” displayed within the avatar menu 26 (step B19: YES), the posting section 513 posts a direct message to the following user (destination) corresponding to the selected avatar 20 (step B21).

The message analysis section 514 then analyzes the message data. Specifically, the message analysis section 514 specifies the message type of the message data, and extracts a given item generation keyword included in the message data (step B23).

The item generation section 515 then determines whether or not the item generation condition has been satisfied based on the keyword extracted from the message data. When the item generation condition has been satisfied, the item generation section 515 determines that the user has acquired the item corresponding to the item generation condition, and adds the item to the items possessed by the user (step B25).

When the user has touched the item “STOP MOTION” displayed within the avatar menu 26 (step B27: YES), the avatar display control section 511 causes the avatar 20 to stop the motion (step B29).

When the user has touched the balloon 22 displayed on the field screen W1 (step B31: YES), the avatar display control section 511 specifies the following user corresponding to the avatar 20 displayed together with the selected balloon 22, and displays the message details screen W2 that shows the latest message posted by the specified following user (step B33).

As shown in FIG. 37, when the user has touched the avatar button 31 displayed on the field screen W1 (step B35: YES), the avatar edit section 512 performs an avatar process (step B37).

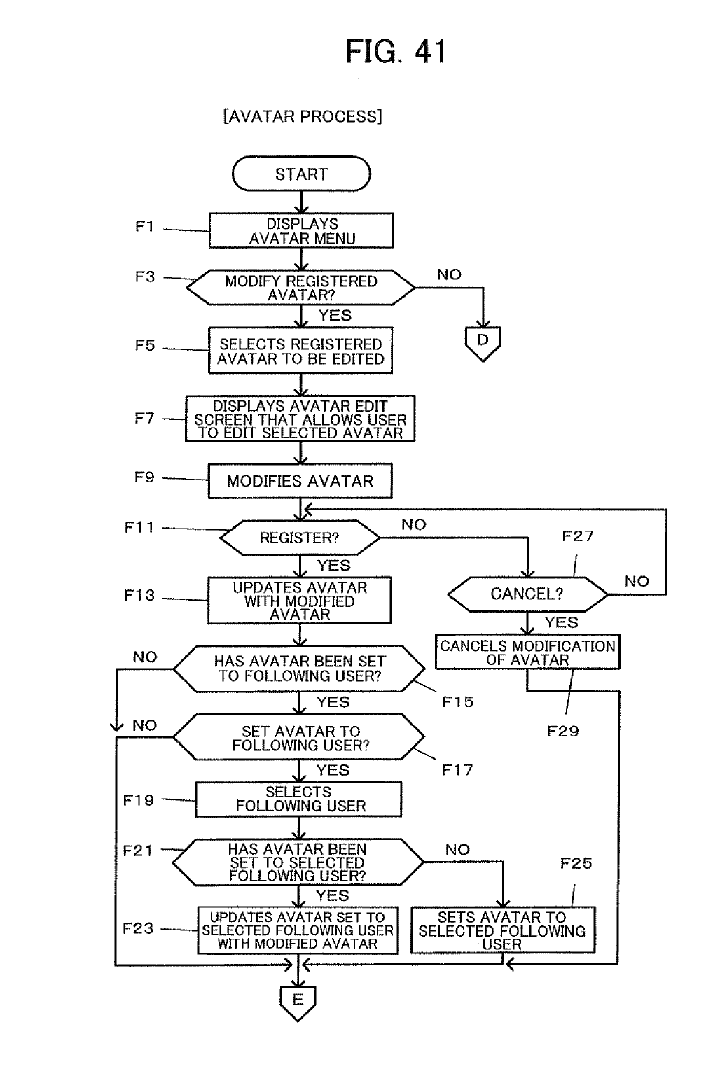

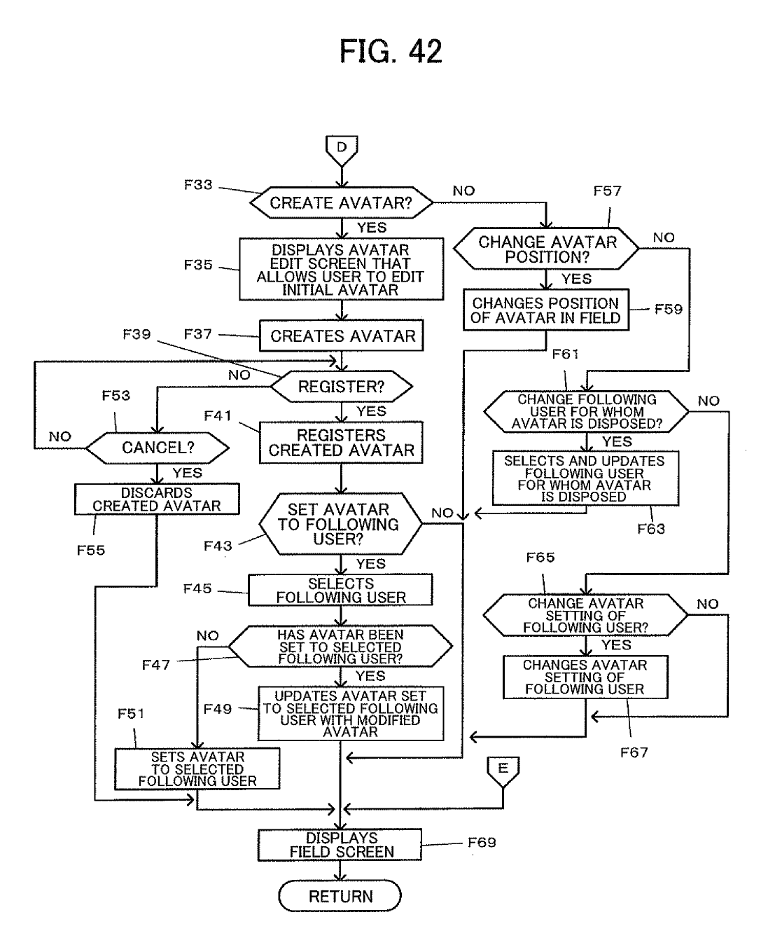

FIGS. 41 and 42 are flowcharts illustrating the flow of the avatar process. As shown in FIG. 41, the avatar edit section 512 displays the avatar menu 28 corresponding to each avatar (step F1).

When the user has touched the item “EDIT AVATAR” displayed within the avatar menu 28, and selected the item “MODIFY REGISTERED AVATAR” (step F3: YES), the avatar edit section 512 selects the registered avatar to be edited from the registered avatars based on an operation performed by the user (step F5). The avatar edit section 512 then displays the avatar edit screen W3 that allows the user to edit the selected registered avatar (step F7). The avatar edit section 512 then modifies the avatar based on an operation performed by the user (step F9).

When the user has selected the item “REGISTER” (step F11: YES), the avatar edit section 512 updates the avatar 20 with the modified avatar (step F13). The avatar edit section 512 then determines whether or not the avatar has been set to one of the following users. When the avatar has not been set to the following users (step F15: NO), the avatar edit section 512 determines whether or not to set the avatar to one of the following users based on an operation performed by the user.

When the avatar is set to one of the following users (step F17: YES), the avatar edit section 512 selects the following user to whom the avatar is set based on an operation performed by the user (step F19). The avatar edit section 512 then determines whether or not the avatar has been set to the selected following user. When the avatar has not been set to the selected following user (step F21: NO), the avatar edit section 512 sets the avatar to the selected following user (step F25). When the avatar has been set to the selected following user (step F21: YES), the avatar edit section 512 updates the avatar set to the selected following user with the modified avatar (step F23). The avatar edit section 512 then displays the field screen W1 (step F69).

When the user has touched the item “EDIT AVATAR” displayed within the avatar menu 28, and selected the item “CREATE” (step F33: YES), the avatar edit section 512 displays the avatar edit screen W3 that allows the user to edit the initial avatar (step F35). The avatar edit section 512 then creates an avatar based on an operation performed by the user (step F37).

When the user has selected the item “REGISTER” (step F39: YES), the avatar edit section 512 registers the created avatar (step F41). The avatar edit section 512 then determines whether or not to set the created avatar to one of the following users based on an operation performed by the user. When the created avatar is set to one of the following users (step F43: YES), the avatar edit section 512 selects the following user to whom the created avatar is set based on an operation performed by the user (step F45).

The avatar edit section 512 then determines whether or not the avatar has been set to the selected following user. When the avatar has not been set to the selected following user (step F47: NO), the avatar edit section 512 sets the created avatar to the selected following user (step F51). When the avatar has been set to the selected following user (step F47: YES), the avatar edit section 512 updates the avatar set to the selected following user with the created avatar (step F49). The avatar edit section 512 then displays the field screen W1 (step F69).

When the user has touched the item “CHANGE AVATAR POSITION” displayed within the avatar menu 28 (step F57: YES), the avatar edit section 512 changes the position of each avatar in the field based on an operation performed by the user (step F59). The avatar edit section 512 then displays the field screen W1 (step F69).

When the user has touched the item “CHANGE AVATAR ASSIGNMENT” displayed within the avatar menu 28 (step F61: YES), the avatar edit section 512 changes (e.g., adds or deletes) the following user for whom the avatar is disposed in the field based on an operation performed by the user (step F63). The avatar edit section 512 then displays the field screen W1 (step F69).

When the user has touched the item “CHANGE AVATAR SETTING OF FOLLOWING USER” displayed within the avatar menu 28 (step F65: YES), the avatar edit section 512 selects the following user for whom the avatar setting is changed based on an operation performed by the user, and changes the avatar setting of the selected following user (step F67). The avatar edit section 512 then displays the field screen W1 (step F69). The avatar process is thus completed.

When the user has touched the update button 34 displayed on the field screen W1 (step B39: YES), the avatar display control section 511 performs a field update process (step B41).

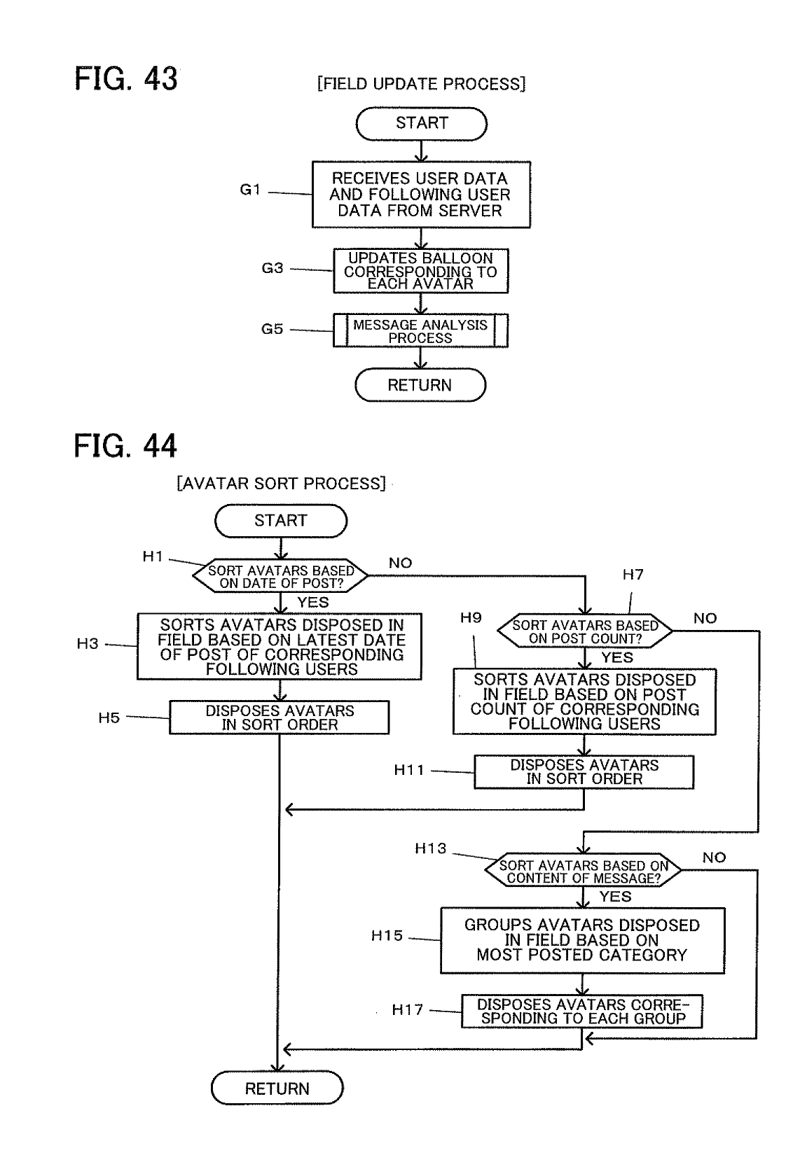

FIG. 43 is a flowchart illustrating the flow of the field update process. As shown in FIG. 43, the avatar display control section 511 acquires the user data and the following user data from the server system 1000 (step G1). The avatar display control section 511 then updates the balloon 22 corresponding to each avatar 20 displayed on the field screen W1 based on the acquired following user data (step G3). Specifically, the avatar display control section 511 specifies the following user who has posted the latest message, enlarges the avatar 20 and the balloon 22 corresponding to the specified following user, and displays a text of the latest message in the balloon 22.

The message analysis section 514 then performs the message analysis process (see FIG. 38) on the acquired following user data (step G5). The field update process is thus completed.

When the user has touched the main button 33 displayed on the field screen W1 (step B43: YES), the main screen W5 of the user is displayed (step B45).

When the user has touched the follow button 35 displayed on the field screen W1 (step B47: YES), a follow list screen (Le., a list of the following users) is displayed (step B49).

Again referring to FIG. 37, when the user has touched the message button 32 displayed on the field screen W1 (step B51: YES), the posting section 513 posts a new message (step B53). The message analysis section 514 then analyzes the message data. Specifically, the message analysis section 514 specifies the message type of the message data, and extracts a given item generation keyword included in the message data (step B55).

The item generation section 515 then determines whether or not the item generation condition has been satisfied based on the keyword extracted from the message data. When the item generation condition has been satisfied, the item generation section 515 determines that the user has acquired the item corresponding to the item generation condition, and adds the item to the items possessed by the user (step B57).

When the user has touched the item button 36 displayed on the field screen W1 (step B59: YES), the item attached to the avatar corresponding to each following user is changed based on an operation performed by the user (step B61).

When the user has touched the sort button 37 displayed on the field screen W1 (step 1363: YES), the avatar display control section 511 performs an avatar sort process (step B65).

FIG. 44 is a flowchart illustrating the flow of the avatar sort process. As shown in FIG. 44, the avatar display control section 511 determines the sort rule based on an operation performed by the user. When the avatar display control section 511 sorts the avatars based on the date of post (step H1: YES), the avatar display control section 511 sorts the avatars 20 disposed in the field 90 based on the latest date of post of the corresponding following users (step H3), and disposes the avatars 20 in the sort order (step H5).

When the avatar display control section 511 sorts the avatars based on the post count (step H7: YES), the avatar display control section 511 sorts the avatars 20 disposed in the field 90 based on the post count of the corresponding following users (step H9), and disposes the avatars 20 in the sort order (step H11).

When the avatar display control section 511 sorts the avatars based on the content of the message (step H13: YES), the avatar display control section 511 specifies the category (most posted category) to which the maximum number of extracted keywords belongs based on the message analysis result data 650 for the corresponding following users, and groups the avatars 20 disposed in the field 90 based on the specified most posted category (step H15). The avatar display control section 511 then disposes the avatars 20 at a given position determined corresponding to each group (step H17). The avatar sort process is thus completed.

Again referring to FIG. 37, the message posting section 510 then determines whether or not to finish the process (e.g., determines whether or not a finish instruction has been input). When the message posting section 510 has determined to continue the process (step B67: NO), the message posting section 510 repeats the process from the step B11. When the message posting section 510 has determined to finish the process (step B67: YES), the message posting section 510 terminates the message posting process.

FIG. 45 is a flowchart illustrating the flow of the regular update process. As shown in FIG. 45, a timer is started (step J1). When the time measured by the timer has reached a given time (step J3: YES), the field update process (see FIG. 43) is performed (step J5). When the field update process has ended, the timer is reset (step J7), and the step J1 is performed again. The regular update process is thus completed.

Effects

According to the above embodiments, the user terminal 2000 displays the field screen W1 on which the avatar 20 corresponding to each following user is displayed. The balloon 22 that indicates that a message has been posted by the corresponding following user is displayed together with the avatar 20. The message posted by the corresponding following user is displayed when the user has touched the balloon 22. This makes it possible to more interestingly display the message posted by another user instead of merely displaying a text of the message posted by the following user.

Since the user can arbitrarily design the avatar 20, the user can design the avatar 20 to resemble the following user, for example. This makes it possible to foster a sense of affinity to the following user, so that the user is more interested in the message posting process. Moreover, since the avatar design data can be posted, the user can share the avatar designed by the user with another user, attach the item 80 to the avatar 20, or cause the avatar 20 to make a motion corresponding to the content of the message, for example.

Modifications

Embodiments to which the invention may be applied are not limited to the above embodiments. Various modifications and variations may be made without departing from the scope of the invention.

(A) Balloon 22

The above embodiments have been described taking an example in which the balloon 22 (i.e., accompanying display object) is displayed corresponding to the avatar 20 as an indicator that indicates that the following user has posted a message. Note that another display object may be displayed. Alternatively, the display state of the avatar 20 may be changed such as changing the display color of the avatar 20, or the avatar 20 may be caused to make a given motion.

(B) Image Posting

When the system allows the user to post an image, and a message posted by the following user includes an image, the display state of the avatar 20 corresponding to the following user may be changed so that the user can be notified that the message includes an image.

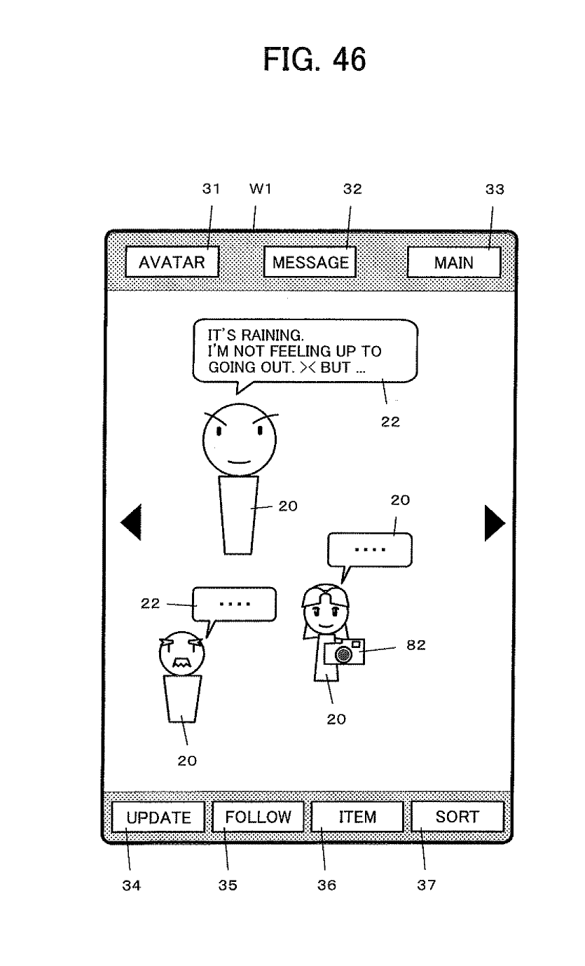

FIG. 46 shows an example of the field screen W1 displayed in such a case. In FIG. 46, a given image icon 82 (camera icon in FIG. 46) that indicates that a message posted by the corresponding following user includes an image is displayed together with the avatar 20. The corresponding image may be displayed when the user has touched the image icon 82. When the message data is text data, an image is posted by incorporating a URL address (identification information about the image) that indicates the location of the image in the message data. Specifically, the image included in the message data can be detected by detecting the URL address included in the message data.

Note that the display color or the motion of the avatar 20 may be changed so that the user can be notified that the message includes an image, for example.

(C) Degree of Intimacy Between Avatars 20

The degree of intimacy may be set between the following users based on the messages posted by the following users, and the display state of the corresponding avatars 20 may be changed based on the degree of intimacy. For example, the degree of intimacy between two following users may be determined based on the number of quote messages posted by one of the two following users and quoting the message posted by the other following user. The position of the avatar 20 corresponding to each following user may be changed based on the degree of intimacy (e.g., the avatars 20 are moved closer to each other as the degree of intimacy increases). When the degree of intimacy has reached a given value, the avatars 20 may be caused to make a motion that indicates a high degree of intimacy (e.g., the avatars 20 face each other, or turn round together).

(D) Avatar Corresponding to User

The above embodiments have been described taking an example in which the avatar corresponding to the following user 20 is displayed on the field screen W1. Note that the avatar corresponding to the user may be displayed (disposed) on the field screen W1.

(E) Item

The above embodiments have been described taking an example in which the user terminal 2000 generates an item that satisfies a given item generation condition based on the user data acquired from the server system 1000. Note that the server system 1000 may generate an item that satisfies a given item generation condition. Specifically, the server system 1000 may determine whether or not each user has satisfied the item generation condition referring to the account registration data 330, and may give an item corresponding to the satisfied item generation condition by transmitting data about the item to the user terminal 2000.

Although only some embodiments of the invention have been described in detail above, those skilled in the art would readily appreciate that many modifications are possible in the embodiments without materially departing from the novel teachings and advantages of the invention. Accordingly, such modifications are intended to be included within the scope of the invention.

What is claimed is:

1. A method that is implemented by a user terminal that can communicate with a given posting site, the method comprising:
setting a character corresponding to a following user;
displaying the character in a given virtual space; and
distinguishably displaying the character corresponding to the following user when message data about the following user is present in the posting site.

2. The method as defined in claim 1,
the setting of the character including setting the character corresponding to the following user by designing each part of the character based on an operation input performed by a user.

3. The method as defined in claim 2, further comprising:
posting the message data about the user including design data about the character to the posting site.

4. The method as defined in claim 1, further comprising:
generating the character based on design data about the character when the message data about the following user includes the design data.

5. The method as defined in claim 1,
the distinguishably displaying of the character including displaying a given accompanying display object to follow the character corresponding to the following user.

6. The method as defined in claim 1, further comprising:
selecting a document destination character from characters displayed in the virtual space; and
transmitting document data to a following user corresponding to the document destination character.

7. The method as defined in claim 1, further comprising:
changing a position of the character in the virtual space based on at least one of a content of the message data, a date of post, and a post frequency of the following user.

8. The method as defined in claim 1, further comprising:
arranging characters disposed in the virtual space based on at least one of a date of post and a post frequency of the following user.

9. The method as defined in claim 1, further comprising:
grouping characters disposed in the virtual space based on whether or not the message data about the following user includes a given keyword.

10. The method as defined in claim 1, further comprising:
determining whether or not an item generation condition has been satisfied based on at least one of a content of the message data and a post count of the following user; and
updating a character corresponding to a following user who has satisfied the item generation condition with the character to which a given item is attached.

11. The method as defined in claim 1, further comprising:
changing a display state of the character corresponding to the following user when the message data about the following user includes image data or identification information that indicates a location of the image data.

12. The method as defined in claim 1, further comprising:
analyzing a content of the message data about the following user; and
controlling a motion of the corresponding character based on a result of the analysis.

13. The method as defined in claim 12,
the analyzing of the content of the message data including analyzing a use frequency and/or a use count of a term by each following user based on the term included in the message data.

14. The method as defined in claim 12,
the analyzing of the content of the message data including determining whether or not a movement instruction command and/or a motion instruction command is included in the message data,
the method further comprising:
causing the corresponding character to make a movement and/or a motion in the virtual space based on the movement instruction command and/or the motion instruction command when it has been determined that the movement instruction command and/or the motion instruction command is included in the message data.

15. The method as defined in claim 1, further comprising:
determining whether or not related message data is included in the message data about the following user, the related message data indicating that a message relates to a message posted by another user;
setting a degree of intimacy between each following user using a result of determination as to whether or not the related message data is included in the message data; and
causing a character corresponding to a following user for whom the degree of intimacy has satisfied a given condition to make a predetermined motion.

16. A non-transitory storage medium storing a program that causes a computer to execute the method as defined in claim 1.

17. A user terminal that can communicate with a given posting site, the user terminal comprising:
a character setting section that sets a character corresponding to a following user;
a character display control section that displays the character set by the character setting section in a given virtual space; and
a distinguishable display section that distinguishably displays the character corresponding to the following user when message data about the following user is present in the posting site.
